(19) United States
(12) Patent Application Publication
(10) Pub. No.: US 2016/0012541 A1
(43) Pub. Date: Jan. 14, 2016

(54) SYSTEMS AND METHODS FOR BUSINESS RECLASSIFICATION TIEBREAKING

(71) Applicant: The Travelers Indemnity Company, Hartford, CT (US)

(72) Inventors: Robert T. Harrington, Cary, IL (US); Timothy J. Fulton, Spring Grove, PA (US)

(21) Appl. No.: 14/328,757

(22) Filed: Jul. 11, 2014

(51) Int. Cl. G06Q 40/08

(52) U.S. Cl. CPC G06Q 40/08

(57) ABSTRACT

Systems, apparatus, interfaces, methods, and articles of manufacture that provide for insurance and/or underwriting product business classification and/or reclassification tiebreaking.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Underwriters, distributors, agents, or sellers of various products (such as insurance or surety products) often must properly categorize a customer's business (e.g., classify the business operations or other information) to develop an accurate rate quote. Unfortunately, a substantial percentage of underwriting decisions are based on incorrect classifications. Such errors in classification may give rise to various adverse consequences such as increased occurrence of losses (e.g., for the underwriter and/or insurer), “premium leakage” (e.g., cases where a policy should have been written for a higher premium—if classified correctly), and/or a distortion of business segment data (which is utilized to determine appropriate premium levels for future underwriting). These and other deficiencies remain unresolved.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a flow diagram of a method according to some embodiments;

FIG. 3 is a flow diagram of a method according to some embodiments;

FIG. 4 is a flow diagram of a method according to some embodiments;

FIG. 5 is a diagram of an exemplary risk matrix according to some embodiments;

FIG. 6 is a block diagram of a system according to some embodiments;

FIG. 7 is a diagram of an example interface according to some embodiments;

FIG. 8A and FIG. 8B are block diagrams of an example data storage structure according to some embodiments;

FIG. 9A and FIG. 9B are diagrams of example interfaces according to some embodiments;

FIG. 10 is a flow diagram of a method according to some embodiments;

FIG. 11 is a block diagram of an apparatus according to some embodiments; and

FIG. 12A, FIG. 12B, FIG. 12C, FIG. 12D, and FIG. 12E are perspective diagrams of exemplary data storage devices according to some embodiments.

### DETAILED DESCRIPTION

Embodiments described herein are descriptive of systems, apparatus, methods, interfaces, and articles of manufacture for “tiebreaking” with respect to business reclassification in insurance underwriting, analysis, quotation, and/or sales processes. In some embodiments for example, an insurance and/or other underwriting process may include an automatic classification and/or reclassification of a business. As described in co-pending U.S. patent application Ser. No. 13/179,464 filed on Jul. 8, 2011 and titled “SYSTEMS AND METHODS FOR BUSINESS CLASSIFICATION” (the business classification concepts and descriptions of which are hereby incorporated by reference herein), it may be desirable to implement novel solutions for automatically classifying a business—as opposed to merely accepting a self-classification designation from an insured, customer, etc. In some embodiments, such automatic business classification may be based on third-party data (such as geospatial data) and/or answers to underwriting and/or business classification refinement questions.

According to some embodiments, such automatic classification may, however, result in identification of multiple business classes that may be appropriate for assigning to a particular business. In certain industry classes, such as technology and/or Information Technology (IT) services businesses (e.g., website providers, Internet Service Provider (ISP) entities, data search providers), for example, there may be overlap between business classification boundaries. As described in further detail elsewhere herein, for example, an answer to an underwriting question may indicate a plurality of possible business classifications for a business. In such embodiments, one of the plurality of possible (and/or preliminary) business classifications may be automatically selected to effectuate the automatic business classification and/or reclassification with respect to an underwriting process.

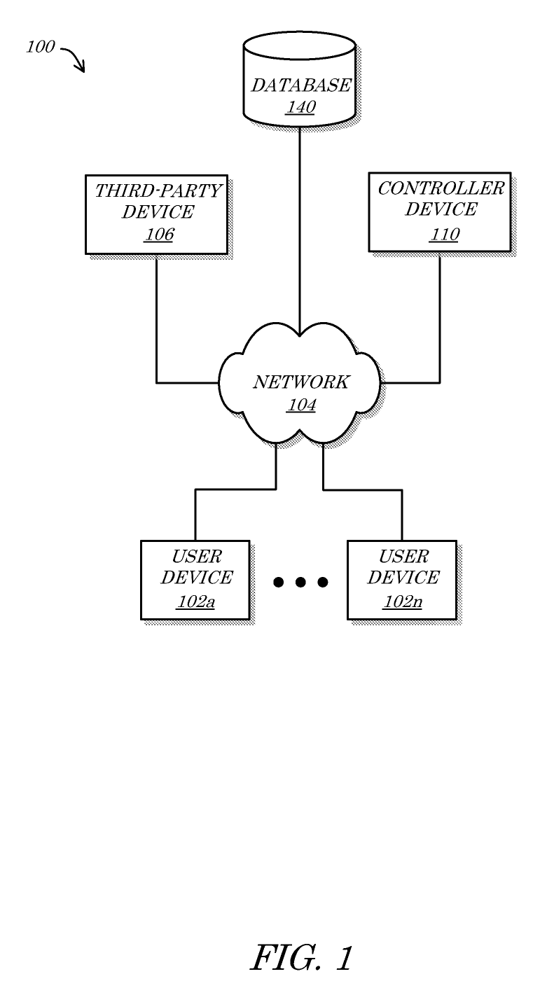

Referring first to FIG. 1, a block diagram of a system 100 according to some embodiments is shown. In some embodiments, the system 100 may comprise a plurality of user devices 102a-n, a network 104, a third-party device 106, a controller device 110, and/or a database 140. As depicted in FIG. 1, any or all of the devices 102a-n, 106, 110, 140 (or any combinations thereof) may be in communication via the network 104. In some embodiments, the system 100 may be utilized to provide (and/or receive) customer data, business classification and/or reclassification data, geo-spatial data, weather data, risk data, claim data, and/or other data or metrics. The controller device 110 may, for example, interface with one or more of the user devices 102a-n and/or the third-party device 106 to provide tiebreaking for automatic business classifications and/or reclassifications in an effort to make an underwriting process (e.g., conducted and/or initiated by one or more of the user devices 102a-n) more efficient and/or effective.

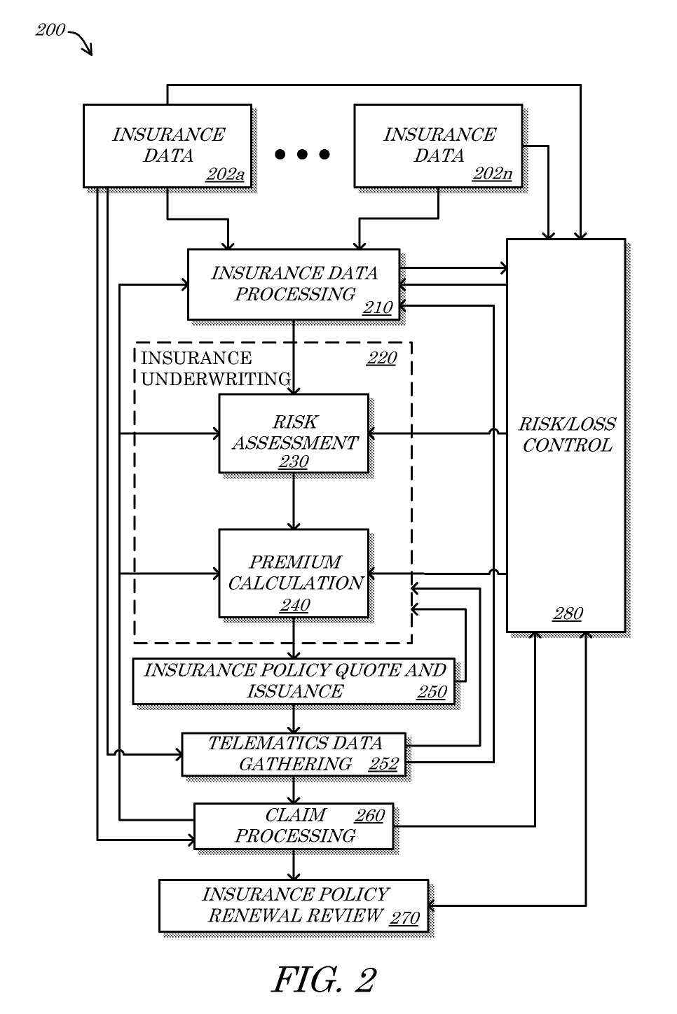

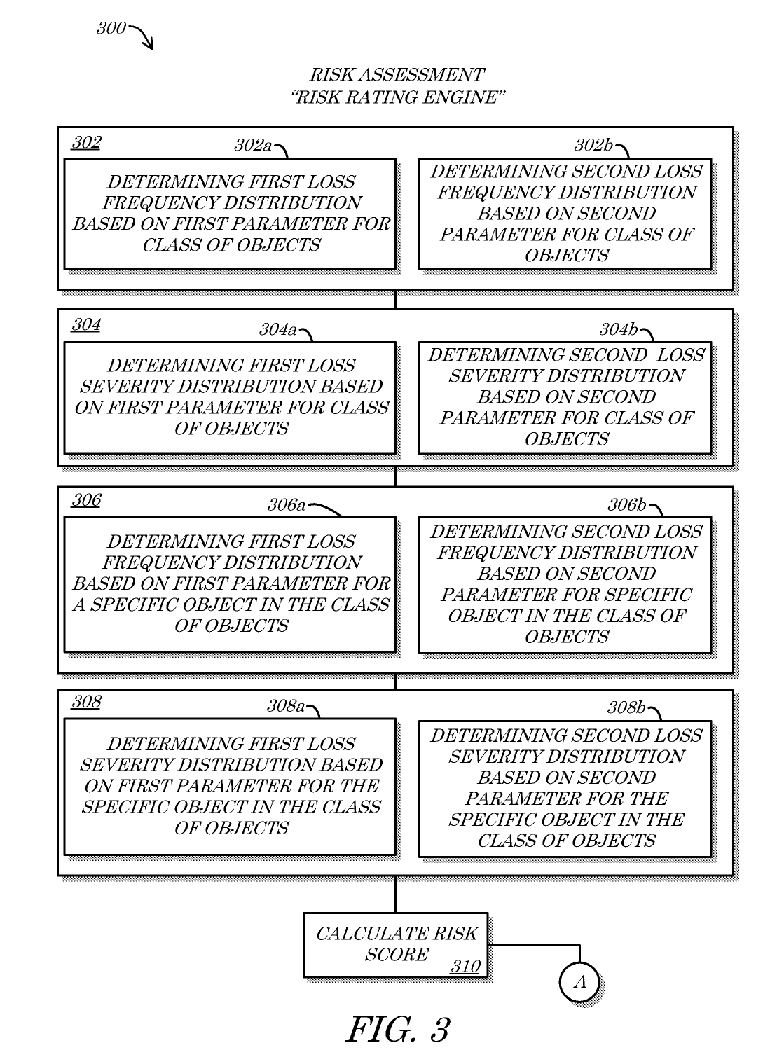

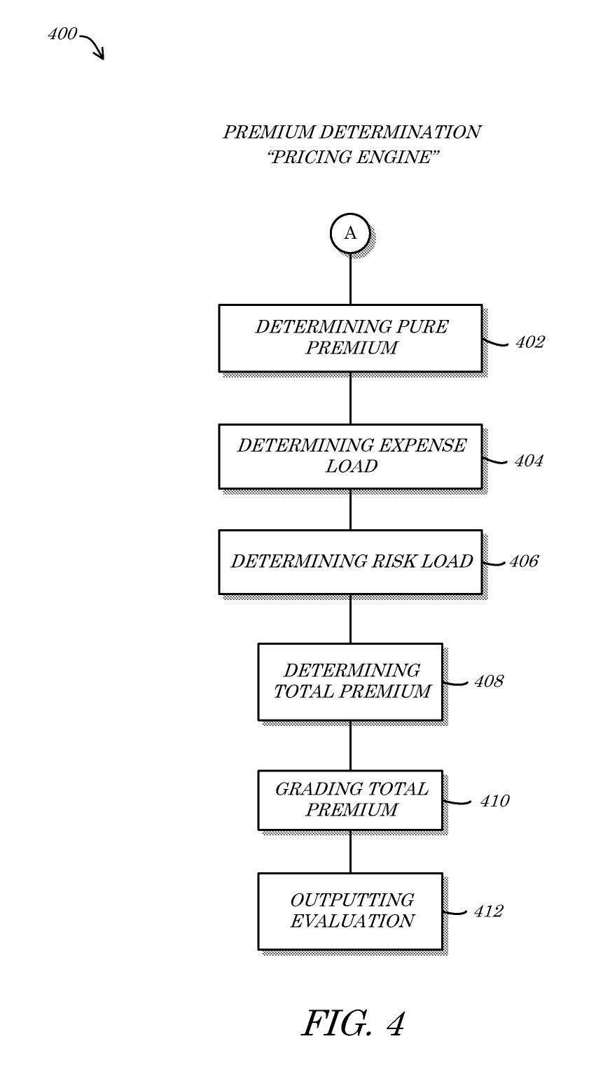

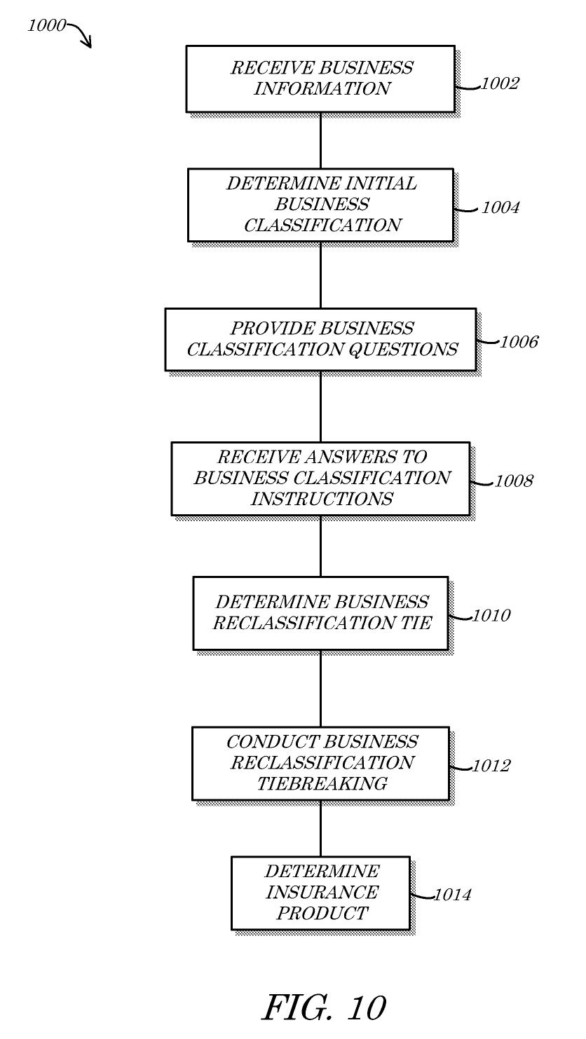

Fewer or more components 102a-n, 104, 106, 110, 140 and/or various configurations of the depicted components 102a-n, 104, 106, 110, 140 may be included in the system 100 without deviating from the scope of embodiments described herein. In some embodiments, the components 102a-n, 104, 106, 110, 140 may be similar in configuration and/or functionality to similarly named and/or numbered components as described herein. In some embodiments, the system 100 (and/or portion thereof) may comprise a risk assessment and/or underwriting or sales program, system, and/or platform programmed and/or otherwise configured to execute, conduct, and/or facilitate any of the various methods 200, 300, 400, 1000 of FIG. 2, FIG. 3, FIG. 4, and/or FIG. 10 herein, and/or portions or combinations thereof.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., claim adjuster and/or handler and/or underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as claim handlers, field agents, underwriters, account managers, agents/brokers, customer service representatives, data acquisition partners and/or consultants or service providers, and/or underwriting product customers (or potential customers, e.g., consumers). According to some embodiments, the user devices 102a-n may communicate with the controller device 110 via the network 104, such as to conduct underwriting inquiries and/or processes utilizing enhanced or “smart” classification subject to automatic business classification tiebreaking as described herein.

In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, the user devices 102a-n may interface with the controller device 110 to effectuate communications (direct or indirect) with the third-party device 106 (such communication also not explicitly shown in FIG. 1). In some embodiments, the user devices 102a-n and/or the third-party device 106 may comprise one or more sensors configured and/or couple to sense, measure, calculate, and/or otherwise process or determine geo-spatial, business classification, weather and/or other risk data, and/or claim data. In some embodiments, such sensor data may be provided to the controller device 110, such as to conduct claim handling, pricing, risk assessment, line and/or limit setting, quoting, and/or selling or re-selling of an underwriting product (e.g., utilizing automatic business classification tiebreaking as described herein).

The network 104 may, according to some embodiments, comprise a Local Area Network (LAN; wireless and/or wired), cellular telephone, Bluetooth®, Near Field Communication (NFC), and/or Radio Frequency (RF) network with communication links between the controller device 110, the user devices 102a-n, the third-party device 106, and/or the database 140. In some embodiments, the network 104 may comprise direct communications links between any or all of the components 102a-n, 106, 110, 140 of the system 100. The user devices 102a-n may, for example, be directly interfaced or connected to one or more of the controller device 110 and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110, 140 of the system 100. The network 104 may comprise one or more cellular telephone networks with communication links between the user devices 102a-n and the controller device 110, for example, and/or may comprise the Internet, with communication links between the controller device 110 and the third-party device 106 and/or the database 140, for example.

The third-party device 106, in some embodiments, may comprise any type or configuration of a computerized processing device such as a PC, laptop computer, computer server, database system, and/or other electronic device, devices, or any combination thereof. In some embodiments, the third-party device 106 may be owned and/or operated by a third-party (i.e., an entity different than any entity owning and/or operating either the user devices 102a-n or the controller device 110). The third-party device 106 may, for example, be owned and/or operated by data and/or data service provider such as Dun & Bradstreet® Credibility Corporation (and/or a subsidiary thereof, such as Hoovers™), Deloitte® Development, LLC, Experian™ Information Solutions, Inc., and/or Edmunds.com®, Inc. In some embodiments, the third-party device 106 may supply and/or provide data such as business and/or other classification data to the controller device 110 and/or the user devices 102a-n. In some embodiments, the third-party device 106 may comprise a plurality of devices and/or may be associated with a plurality of third-party entities.

In some embodiments, the controller device 110 may comprise an electronic and/or computerized controller device such as a computer server communicatively coupled to interface with the user devices 102a-n and/or the third-party device 106 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n and/or the third-party device 106. The controller device 110 may also or alternatively comprise a plurality of electronic processing devices located at one or more various sites and/or locations.

According to some embodiments, the controller device 110 may store and/or execute specially programmed instructions to operate in accordance with embodiments described herein. The controller device 110 may, for example, execute one or more programs that facilitate the enhanced or smart classification of underwriting product clients, customers, businesses, products, and/or other associated metrics as utilized in insurance and/or risk analysis, and/or handling, processing, pricing, underwriting, and/or issuance of one or more insurance and/or underwriting products and/or claims with respect thereto. According to some embodiments, the controller device 110 may comprise a computerized processing device such as a PC, laptop computer, computer server, and/or other electronic device to manage and/or facilitate transactions and/or communications regarding the user devices 102a-n. An insurance company employee, agent, claim handler, underwriter, and/or other user (e.g., customer, consumer, client, or company) may, for example, utilize the controller device 110 to (i) price and/or underwrite one or more products, such as insurance, indemnity, and/or surety products, (ii) determine and/or be provided with business and/or other classification information in an enhanced manner as described herein, (iii) determine and/or be provided with business classification and/or other reclassification based on answers to underwriting and/or business classification questions, (iv) implement a business classification/reclassification tiebreaking process as described herein, and/or (v) provide an interface via which an underwriting entity may manage and/or facilitate underwriting of various products (e.g., in accordance with embodiments described herein).

In some embodiments, the controller device 110 and/or the third-party device 106 (and/or the user devices 102a-n) may be in communication with the database 140. The database 140 may store, for example, location data obtained from the user devices 102a-n, business classification/reclassification and/or tiebreaking data defined by the controller device 110, and/or instructions that cause various devices (e.g., the controller device 110 and/or the user devices 102a-n) to operate in accordance with embodiments described herein. In some embodiments, the database 140 may comprise any type, configuration, and/or quantity of data storage devices that are or become known or practicable. The database 140 may, for example, comprise an array of optical and/or solid-state hard drives configured to store location data provided by (and/or requested by) the user devices 102a-n, business classification data, business reclassification data, business classification tiebreaking data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the user devices 102a-n or third-party device 106 may comprise the database 140 or a portion thereof, for example, and/or the controller device 110 may comprise the database or a portion thereof.

Referring now to FIG. 2, a flow diagram of a method 200 according to some embodiments is shown. In some embodiments, the method 200 may be performed and/or implemented by and/or otherwise associated with one or more specialized and/or specially-programmed computers (e.g., the user devices 102a-n, the third-party device 106, and/or the controller device 110, all of FIG. 1), computer terminals, computer servers, computer systems and/or networks, and/or any combinations thereof (e.g., by one or more insurance company and/or underwriter computers).

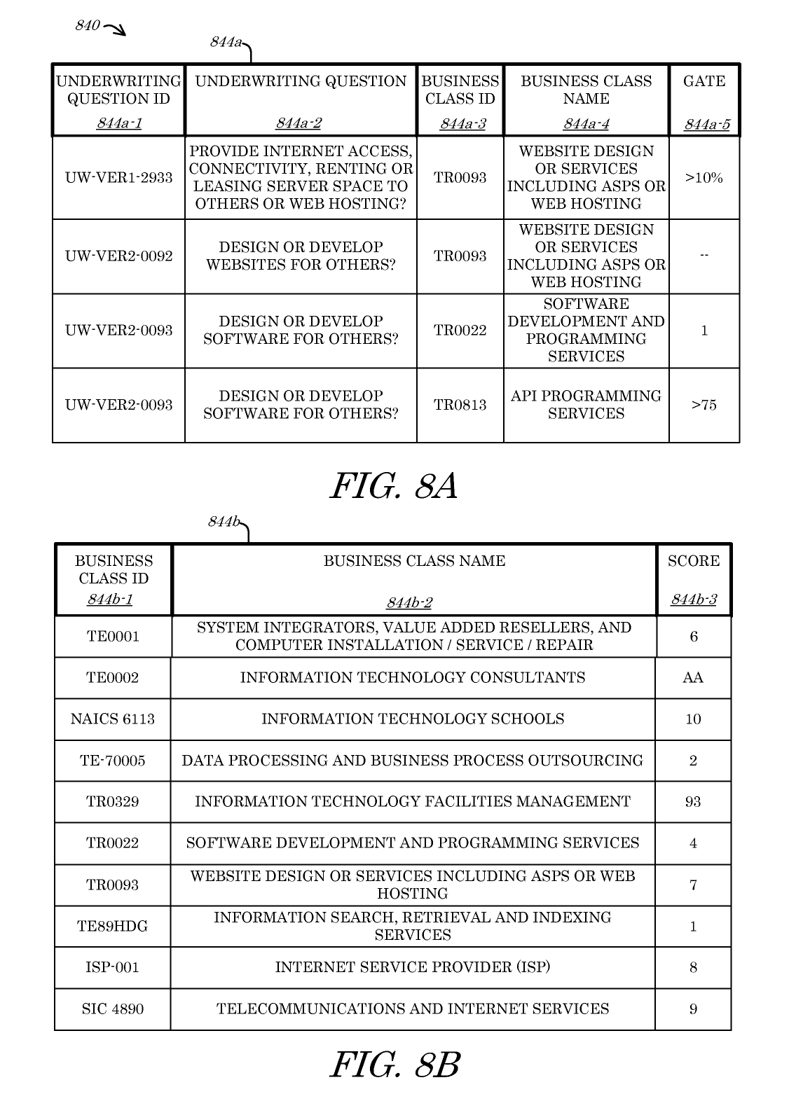

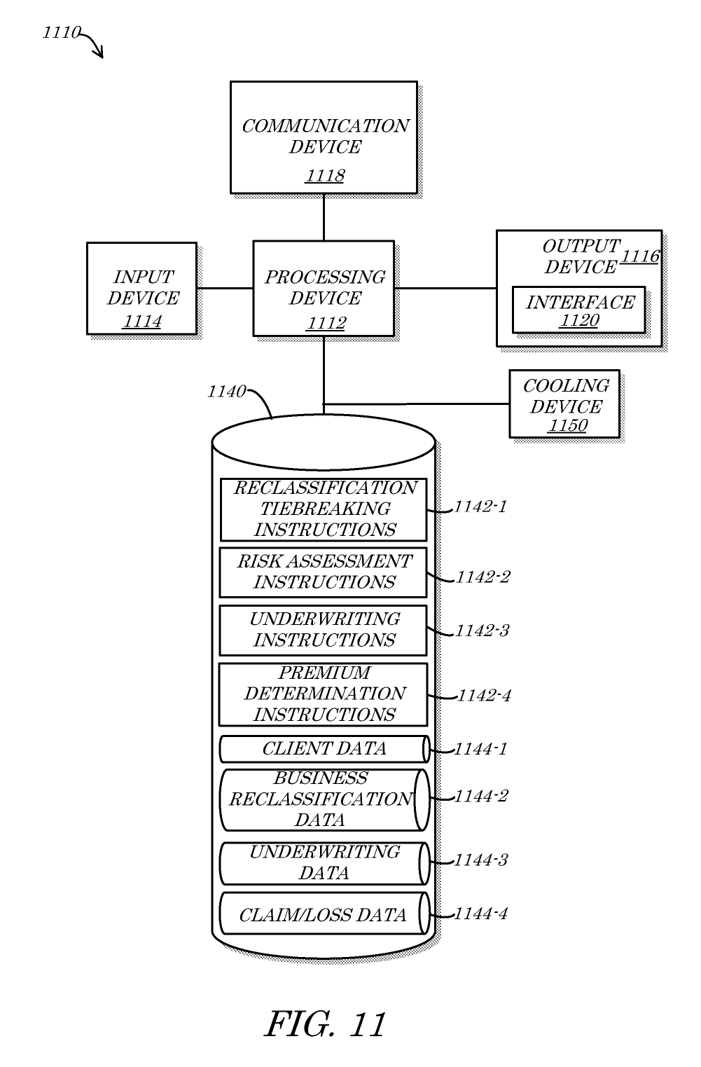

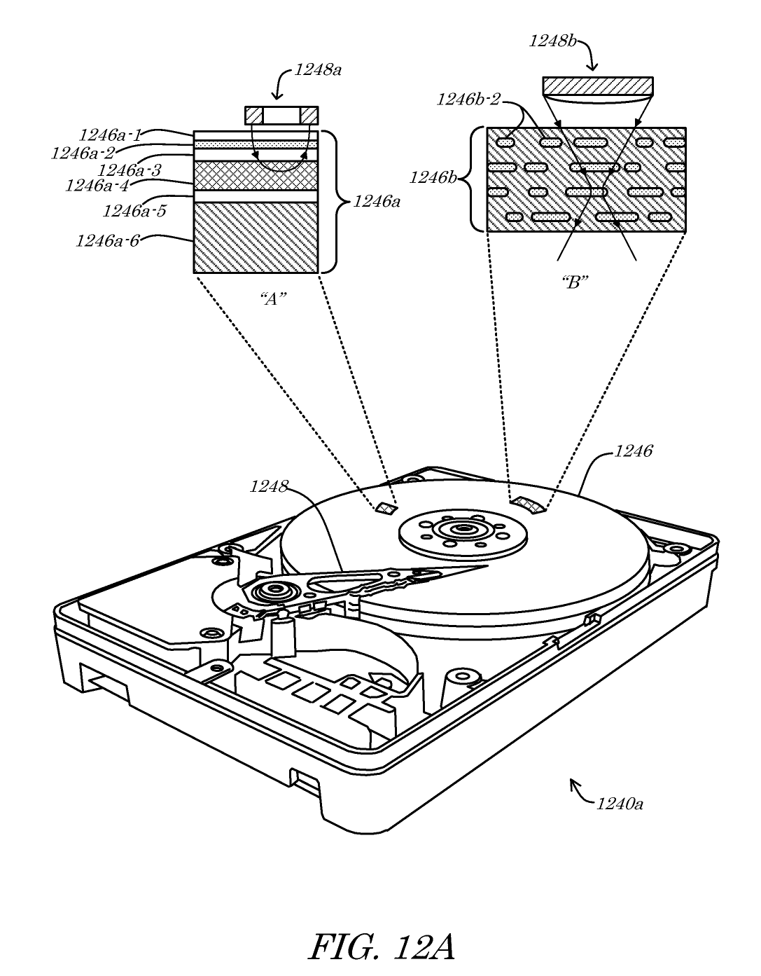

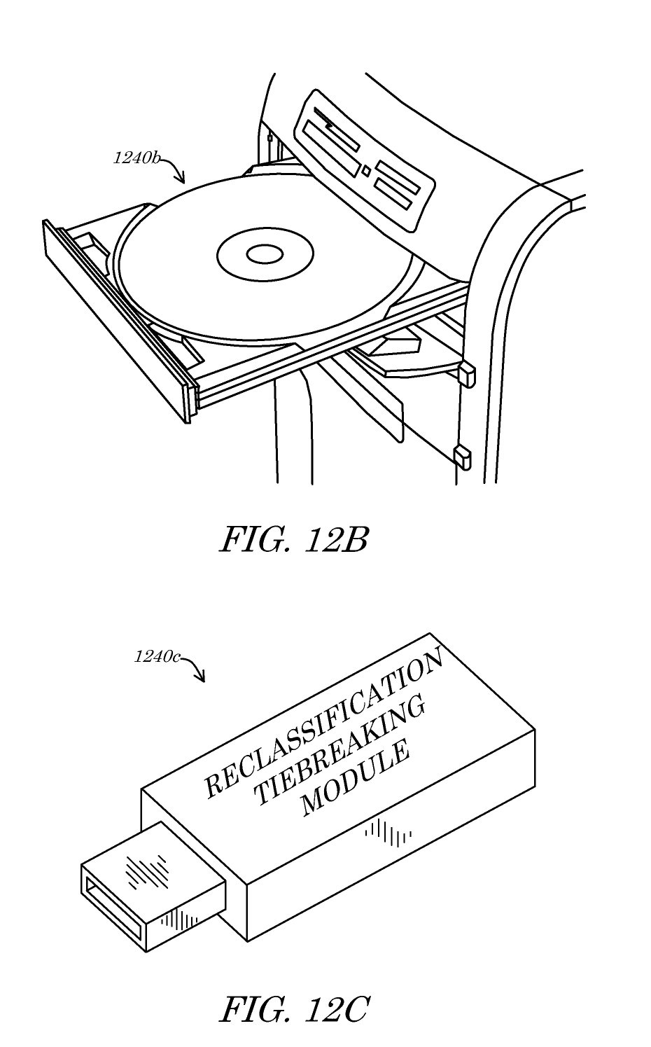

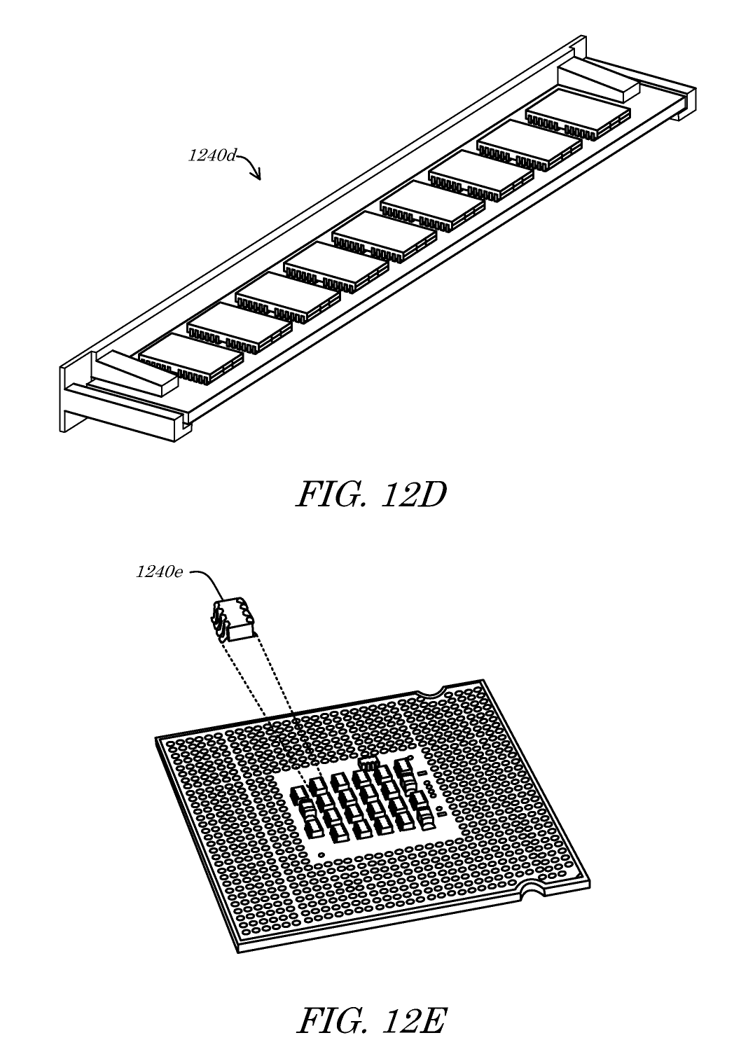

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 140, 840, 1140, 1240a-e of FIG. 1, FIG. 8, FIG. 11, FIG. 12A, FIG. 12B, FIG. 12C, FIG. 12D, and/or FIG. 12E herein) may store thereon instructions that when executed by a machine (such as a computerized processor) result in performance according to any one or more of the embodiments described herein.

According to some embodiments, the method 200 may comprise one or more actions associated with insurance data 202a-n. The insurance data 202a-n of one or more objects and/or areas that may be related to and/or otherwise associated with an insurance territory, account, customer, insurance product and/or policy, for example, may be determined, calculated, looked-up, retrieved, and/or derived. In some embodiments, the insurance data 202a-n may be gathered as raw data directly from one or more data sources.

As depicted in FIG. 2, insurance data 202a-n from a plurality of data sources may be gathered. In some embodiments, the insurance data 202a-n may comprise information indicative of various types of perils, risks, geo-spatial data, business data, customer and/or consumer data, and/or other data that is or becomes useful or desirable for the conducting of risk assessment and/or underwriting processes. The insurance data 202a-n may comprise, for example, business location data, business classification data (e.g., acquired and/or derived from one or more third-party sources), business characteristic data (e.g., annual sales, receipts, payroll, square footage of business operations space), etc. The insurance data 202a-n may be acquired from any quantity and/or type of available source that is or becomes desired and/or practicable, such as from one or more sensors, databases, and/or third-party devices. In some embodiments, the insurance data 202a-n may comprise geospatial and/or geo-coded data relating various peril metrics to one or more geographic locations. In some embodiments, the insurance data 202a-n may comprise business classification risk, ranking, and/or scoring data utilized to effectuate business classification tiebreaking as described herein.

According to some embodiments, the method 200 may also or alternatively comprise one or more actions associated with insurance data processing 210. As depicted in FIG. 2, for example, some or all of the insurance data 202a-n may be determined, gathered, transmitted and/or received, and/or otherwise obtained for insurance data processing 210. In some embodiments, insurance data processing 210 may comprise aggregation, analysis, calculation, filtering, conversion, encoding and/or decoding (including encrypting and/or decrypting), sorting, ranking, de-duping, and/or any combinations thereof.

According to some embodiments, a processing device may execute specially programmed instructions to process (e.g., the insurance data processing 210) the insurance data 202a-n to define one or more business classifications applicable to a business and/or to select a business classification from a plurality of possible and/or applicable business classifications (e.g., business classification tiebreaking).

In some embodiments, the method 200 may also or alternatively comprise one or more actions associated with insurance underwriting 220. Insurance underwriting 220 may generally comprise any type, variety, and/or configuration of underwriting process and/or functionality that is or becomes known or practicable. Insurance underwriting 220 may comprise, for example, simply consulting a pre-existing rule, criteria, and/or threshold to determine if an insurance product may be offered, underwritten, and/or issued to clients, based on any relevant insurance data 202a-n. One example of an insurance underwriting 220 process may comprise one or more of a risk assessment 230 and/or a premium calculation 240 (e.g., as shown in FIG. 2). In some embodiments, while both the risk assessment 230 and the premium calculation 240 are depicted as being part of an exemplary insurance underwriting 220 procedure, either or both of the risk assessment 230 and the premium calculation 240 may alternatively be part of a different process and/or different type of process (and/or may not be included in the method 200, as is or becomes practicable and/or desirable). In some embodiments, the insurance data 202a-n may be utilized in the insurance underwriting 220 and/or portions or processes thereof (the insurance data 202a-n may be utilized, at least in part for example, to determine, define, identify, recommend, and/or select a coverage type and/or limit and/or type and/or configuration of underwriting product).

In some embodiments, the insurance data 202a-n and/or a result of the insurance data processing 210 may be determined and utilized to conduct the risk assessment 230 for any of a variety of purposes. In some embodiments, the risk assessment 230 may be conducted as part of a rating process for determining how to structure an insurance product and/or offering. A “risk rating engine” utilized in an insurance underwriting process may, for example, retrieve a risk metric (e.g., provided as a result of the insurance data processing 210) for input into a calculation (and/or series of calculations and/or a mathematical model) to determine a level of risk or the amount of risky behavior likely to be associated with a particular object and/or area (e.g., being associated with one or more particular perils). In some embodiments, the risk assessment 230 may comprise determining that a client views and/or utilizes insurance data (e.g., made available to the client via the insurance company and/or a third-party). In some embodiments, the risk assessment 230 (and/or the method 200) may comprise providing risk control recommendations (e.g., recommendations and/or suggestions directed to reduction of risk, premiums, loss, etc.).

According to some embodiments, the method 200 may also or alternatively comprise one or more actions associated with premium calculation 240 (e.g., which may be part of the insurance underwriting 220). In the case that the method 200 comprises the insurance underwriting 220 process, for example, the premium calculation 240 may be utilized by a “pricing engine” to calculate (and/or look-up or otherwise determine) an appropriate premium to charge for an insurance policy associated with the object and/or area for which the insurance data 202a-n was collected and for which the risk assessment 230 was performed. In some embodiments, the object and/or area analyzed may comprise an object and/or area for which an insurance product is sought (e.g., the analyzed object may comprise a property for which a property insurance policy is desired or a business for which business insurance is desired). According to some embodiments, the object and/or area analyzed may be an object and/or area other than the object and/or area for which insurance is sought (e.g., the analyzed object and/or area may comprise a levy or drainage pump in proximity to the property for which the business insurance policy is desired).

According to some embodiments, the method 200 may also or alternatively comprise one or more actions associated with insurance policy quote and/or issuance 250. Once a policy has been rated, priced, or quoted (e.g., in accordance with an automatically-determined business classification, such as a result of a business classification tiebreaking process) and the customer/client has accepted the coverage terms, the insurance company may, for example, bind and issue the policy by hard copy and/or electronically to the client/insured. In some embodiments, the quoted and/or issued policy may comprise a personal insurance policy, such as a property damage and/or liability policy, and/or a business insurance policy, such as a business liability policy, and/or a property damage policy.

In general, a client/customer may visit a website and/or an insurance agent, for example, provide the needed information about the client and type of desired insurance, and request an insurance policy and/or product. According to some embodiments, the insurance underwriting 220 may be performed utilizing information about the potential client and the policy may be issued as a result thereof. Insurance coverage may, for example, be evaluated, rated, priced, and/or sold to one or more clients, at least in part, based on the insurance data 202a-n. In some embodiments, an insurance company may have the potential client indicate electronically, on-line, or otherwise whether they have any peril-sensing and/or location-sensing (e.g., telematics) devices (and/or which specific devices they have) and/or whether they are willing to install them or have them installed. In some embodiments, this may be done by check boxes, radio buttons, or other form of data input/selection, on a web page and/or via a mobile device application.

In some embodiments, the method 200 may comprise telematics data gathering, at 252. In the case that a client desires to have telematics data monitored, recorded, and/or analyzed, for example, not only may such a desire or willingness affect policy pricing (e.g., affect the premium calculation 240), but such a desire or willingness may also cause, trigger, and/or facilitate the transmitting and/or receiving, gathering, retrieving, and/or otherwise obtaining insurance data 202a-n from one or more telematics devices. As depicted in FIG. 2, results of the telematics data gathering at 252 may be utilized to affect the insurance data processing 210, the risk assessment 230, and/or the premium calculation 240 (and/or otherwise may affect the insurance underwriting 220).

According to some embodiments, the method 200 may also or alternatively comprise one or more actions associated with claims 260. In the insurance context, for example, after an insurance product is provided and/or policy is issued (e.g., via the insurance policy quote and issuance 250), and/or during or after telematics data gathering 252, one or more insurance claims 260 may be filed against the product/policy. In some embodiments, such as in the case that a first object associated with the insurance policy is somehow involved with one or more insurance claims 260, the insurance data 202a-n of the object or related objects may be gathered and/or otherwise obtained. According to some embodiments, such insurance data 202a-n may comprise data indicative of a level of risk of the object and/or area (or area in which the object was located) at the time of casualty or loss (e.g., as defined by the one or more claims 260). Information on claims 260 may be provided to the insurance data processing 210, risk assessment 230, and/or premium calculation 240 to update, improve, and/or enhance these procedures and/or associated software and/or devices. In some embodiments, insurance data 202a-n may be utilized to determine, inform, define, and/or facilitate a determination or allocation of responsibility related to a loss (e.g., the insurance data 202a-n may be utilized to determine an allocation of weighted liability amongst those involved in the incident(s) associated with the loss).

In some embodiments, the method 200 may also or alternatively comprise insurance policy renewal review 270. Insurance data 202a-n (and/or associated business classification data) may be utilized, for example, to determine if and/or how an existing insurance policy (e.g., provided via the insurance policy quote and issuance 250) may be renewed. According to some embodiments, such as in the case that a client is involved with and/or in charge of (e.g., responsible for) providing the insurance data 202a-n (e.g., such as location data indicative of one or more particular property, building, and/or structure attributes), a review may be conducted to determine if the correct amount, frequency, and/or type or quality of the insurance data 202a-n was indeed provided by the client during the original term of the policy. In the case that the insurance data 202a-n was lacking, the policy may not, for example, be renewed and/or any discount received by the client for providing the insurance data 202a-n may be revoked or reduced. In some embodiments, the client may be offered a discount for having certain sensing devices or being willing to install them or have them installed (or be willing to adhere to certain thresholds based on measurements from such devices). In some embodiments, analysis of the received insurance data 202a-n in association with the policy may be utilized to determine if the client conformed to various criteria and/or rules set forth in the original policy. In the case that the client satisfied applicable policy requirements (e.g., as verified by received insurance data 202a-n), the policy may be eligible for renewal and/or discounts. In the case that deviations from policy requirements are determined (e.g., based on the insurance data 202a-n), the policy may not be eligible for renewal, a different policy may be applicable, and/or one or more surcharges and/or other penalties may be applied.

According to some embodiments, the method 200 may comprise one or more actions associated with risk/loss control 280. Any or all data (e.g., insurance data 202a-n and/or other data) gathered as part of a process for claims 260, for example, may be gathered, collected, and/or analyzed to determine how (if at all) one or more of a risk rating engine (e.g., the risk assessment 230), a pricing engine (e.g., the premium calculation 240), the insurance underwriting 220, and/or the insurance data processing 210, should be updated to reflect actual and/or realized risk, costs, and/or other issues associated with the insurance data 202a-n. Results of the risk/loss control 280 may, according to some embodiments, be fed back into the method 200 to refine the risk assessment 230, the premium calculation 240 (e.g., for subsequent insurance queries and/or calculations), the insurance policy renewal review 270 (e.g., a re-calculation of an existing policy for which the one or more claims 260 were filed), and/or the insurance data processing 210 to appropriately scale the output of the risk assessment 230.

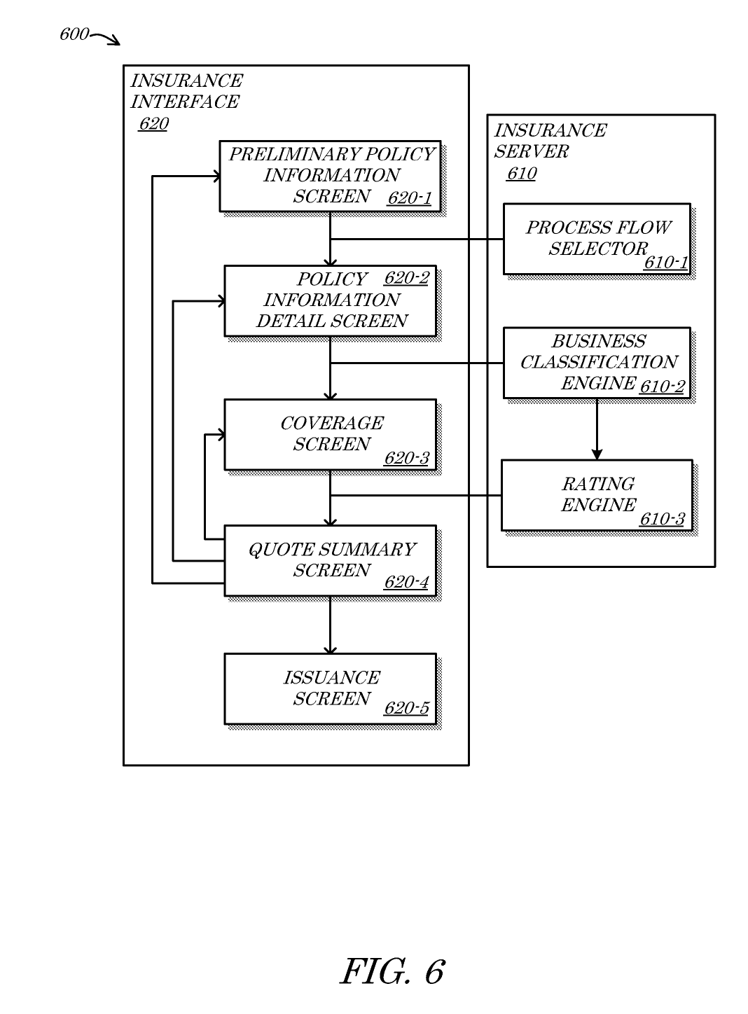

Referring now to FIG. 3, a flow diagram of a method 300 according to some embodiments is shown. In some embodiments, the method 300 may comprise risk assessment method which may, for example, be described as a “risk rating engine”. According to some embodiments, the method 300 may be implemented, facilitated, and/or performed by or otherwise associated with the systems 100, 600 of FIG. 1 and/or FIG. 6 herein. In some embodiments, the method 300 may be associated with the method 200 of FIG. 2. The method 300 may, for example, comprise a portion of the method 200 such as the risk assessment 230.

According to some embodiments, the method 300 may comprise determining one or more loss frequency distributions for a class of objects, at 302 (e.g., 302a-b). In some embodiments, a first loss frequency distribution may be determined, at 302a, based on a first parameter, data and/or metrics. Insurance data (such as the insurance data 202a-n of FIG. 2 and/or a portion thereof) for a class of objects such as a class of business and/or for a particular type of business (such as an IT networking services company) within a class of objects (such as IT services) may, for example, be analyzed to determine relationships between various data and/or metrics and empirical data descriptive of actual insurance losses for such business types and/or classes of business. A risk processing and/or analytics system and/or device (e.g., the controller device 110 as described with respect to FIG. 1 herein) may, according to some embodiments, conduct regression and/or other mathematical analysis on various risk metrics to determine and/or identify mathematical relationships that may exist between such metrics and actual sustained losses and/or casualties.

Similarly, at 302b, a second loss frequency distribution may be determined based on a second parameter for the class of objects. According to some embodiments, the determining at 302b may comprise a standard or typical loss frequency distribution utilized by an entity (such as an insurance company) to assess risk. The second parameter and/or parameters utilized as inputs in the determining at 302b may include, for example, age of a building, proximity to emergency services, etc. In some embodiments, the loss frequency distribution determinations at 302a-b may be combined and/or determined as part of a single comprehensive loss frequency distribution determination. In such a manner, for example, expected total loss probabilities (e.g., taking into account both first parameter and second parameter data) for a particular object type and/or class may be determined. In some embodiments, this may establish and/or define a baseline, datum, average, and/or standard with which individual and/or particular risk assessments may be measured.

According to some embodiments, the method 300 may comprise determining one or more loss severity distributions for a class of objects, at 304 (e.g., 304a-b). In some embodiments, a first loss severity distribution may be determined, at 304a, based on the first parameter for the class of objects. Business classification data (such as the insurance data 202a-n of FIG. 2) for a class of objects such as location objects and/or for a particular type of object (such as a drycleaner) may, for example, be analyzed to determine relationships between various first parameter metrics and empirical data descriptive of actual insurance losses for such object types and/or classes of objects. A risk processing and/or analytics system (e.g., the controller device 110 as described with respect to FIG. 1) may, according to some embodiments, conduct regression and/or other analysis on various metrics to determine and/or identify mathematical relationships that may exist between such metrics and actual sustained losses and/or casualties.

Similarly, at 304b, a second loss severity distribution may be determined based on the second parameter for the class of objects. According to some embodiments, the determining at 304b may comprise a standard or typical loss severity distribution utilized by an entity (such as an insurance agency) to assess risk. The second parameter and/or parameters utilized as inputs in the determining at 304b may include, for example, cost of replacement or repair, ability to self-mitigate loss (e.g., if a building has a fire suppression system and/or automatically closing fire doors, floor drains), etc. In some embodiments, the loss severity distribution determinations at 304a-b may be combined and/or determined as part of a single comprehensive loss severity distribution determination. In such a manner, for example, expected total loss severities (e.g., taking into account both first parameter and second parameter data) for a particular object type and/or class may be determined. In some embodiments, this may also or alternatively establish and/or define a baseline, datum, average, and/or standard with which individual and/or particular risk assessments may be measured.

In some embodiments, the method 300 may comprise determining one or more expected loss frequency distributions for a specific object (and/or account or other group of objects) in the class of objects, at 306 (e.g., 306a-b). Regression and/or other mathematical analysis performed on the first parameter loss frequency distribution derived from empirical data, at 302a for example, may identify various first parameter metrics and may mathematically relate such metrics to expected loss occurrences (e.g., based on historical trends). Based on these relationships, a first parameter loss frequency distribution may be developed at 306a for the specific object (and/or account or other group of objects). In such a manner, for example, known first parameter metrics for a specific object (and/or account or other group of objects) may be utilized to develop an expected distribution (e.g., probability) of occurrence of first parameter-related loss for the specific object (and/or account or other group of objects).

Similarly, regression and/or other mathematical analysis performed on the second parameter loss frequency distribution derived from empirical data, at 302b for example, may identify various second parameter metrics and may mathematically relate such metrics to expected loss occurrences (e.g., based on historical trends). Based on these relationships, a second parameter loss frequency distribution may be developed at 306b for the specific object (and/or account or other group of objects). In such a manner, for example, known second parameter metrics for a specific object may be utilized to develop an expected distribution (e.g., probability) of occurrence of second parameter-related loss for the specific object (and/or account or other group of objects). In some embodiments, the second parameter loss frequency distribution determined at 306b may be similar to a standard or typical loss frequency distribution utilized by an insurer to assess risk.

In some embodiments, the method 300 may comprise determining one or more expected loss severity distributions for a specific object (and/or account or other group of objects) in the class of objects, at 308 (e.g., 308a-b). Regression and/or other mathematical analysis performed on the first parameter loss severity distribution derived from empirical data, at 304a for example, may identify various first parameter risk metrics and may mathematically relate such metrics to expected loss severities (e.g., based on historical trends). Based on these relationships, a first parameter loss severity distribution may be developed at 308a for the specific object (and/or account or other group of objects). In such a manner, for example, known first parameter metrics for a specific object (and/or account or other group of objects) may be utilized to develop an expected severity for occurrences of first parameter-related loss for the specific object (and/or account or other group of objects).

Similarly, regression and/or other mathematical analysis performed on the second parameter loss severity distribution derived from empirical data, at 304b for example, may identify various second parameter metrics and may mathematically relate such metrics to expected loss severities (e.g., based on historical trends). Based on these relationships, a second parameter loss severity distribution may be developed at 308b for the specific object (and/or account or other group of objects). In such a manner, for example, known second parameter metrics for a specific object (and/or account or other group of objects) may be utilized to develop an expected severity of occurrences of second parameter-related loss for the specific object (and/or account or other group of objects). In some embodiments, the second parameter loss severity distribution determined at 308b may be similar to a standard or typical loss frequency distribution utilized by an insurer to assess risk.

It should also be understood that the first parameter-based determinations 302a, 304a, 306a, 308a and second parameter-based determinations 302b, 304b, 306b, 308b are separately depicted in FIG. 3 for ease of illustration of one embodiment descriptive of how risk metrics may be included to enhance standard risk assessment procedures. According to some embodiments, the first parameter-based determinations 302a, 304a, 306a, 308a and second parameter-based determinations 302b, 304b, 306b, 308b may indeed be performed separately and/or distinctly in either time or space (e.g., they may be determined by different software and/or hardware modules or components and/or may be performed serially with respect to time). In some embodiments, the first parameter-based determinations 302a, 304a, 306a, 308a and second parameter-based determinations 302b, 304b, 306b, 308b may be incorporated into a single risk assessment process or “engine” that may, for example, comprise a risk assessment software program, package, and/or module. According to some embodiments either or both of the first parameter and second parameter may comprise a plurality of parameters, variables, and/or metrics.

In some embodiments, the method 300 may comprise calculating a risk score (e.g., for an object, account, and/or group of objects—e.g., objects related in a manner other than sharing an identical or similar class designation), at 310. According to some embodiments, formulas, charts, and/or tables may be developed that associate various first parameter and/or second parameter metric magnitudes with risk scores. Risk scores for a plurality of first parameter and/or second parameter metrics may be determined, calculated, tabulated, and/or summed to arrive at a total risk score for an object and/or account (e.g., a business, a property, a property feature, a portfolio and/or group of properties and/or objects subject to a particular risk) and/or for an object class. According to some embodiments, risk scores may be derived from the first parameter and/or second parameter loss frequency distributions and the first parameter and/or second parameter loss severity distribution determined at 306a-b and 308a-b, respectively. More details on one method for assessing risk are provided in commonly-assigned U.S. Pat. No. 7,330,820 entitled “PREMIUM EVALUATION SYSTEMS AND METHODS,” which issued on Feb. 12, 2008, the risk assessment concepts and descriptions of which are hereby incorporated by reference herein.

In some embodiments, the method 300 may also or alternatively comprise providing various recommendations, suggestions, guidelines, and/or rules directed to reducing and/or minimizing risk, premiums, etc. According to some embodiments, the results of the method 300 may be utilized to determine a premium for an insurance policy for, e.g., a specific business, object, and/or account analyzed. Any or all of the first parameter and/or second parameter loss frequency distributions of 306a-b, the first parameter and/or second parameter loss severity distributions of 308a-b, and the risk score of 310 may, for example, be passed to and/or otherwise utilized by a premium calculation process via the node labeled “A” in FIG. 3.

Turning to FIG. 4, for example, a flow diagram of a method 400 (that may initiate at the node labeled “A”) according to some embodiments is shown. In some embodiments, the method 400 may comprise a premium determination method which may, for example, be described as a “pricing engine”. According to some embodiments, the method 400 may be implemented, facilitated, and/or performed by or otherwise associated with the systems 100, 600 of FIG. 1 and/or FIG. 6 herein. In some embodiments, the method 400 may be associated with the method 200 of FIG. 2. The method 400 may, for example, comprise a portion of the method 200 such as the premium calculation 240. Any other technique for calculating an insurance premium that uses insurance information described herein may be utilized, in accordance with some embodiments, as is or becomes practicable and/or desirable.

In some embodiments, the method 400 may comprise determining a pure premium, at 402. A pure premium is a basic, unadjusted premium that is generally calculated based on loss frequency and severity distributions. According to some embodiments, the first parameter and/or second parameter loss frequency distributions (e.g., from 306a-b in FIG. 3) and the first parameter and/or second parameter loss severity distributions (e.g., from 308a-b in FIG. 3) may be utilized to calculate a pure premium that would be expected, mathematically, to result in no net gain or loss for the insurer when considering only the actual cost of the loss or losses under consideration and their associated loss adjustment expenses. Determination of the pure premium may generally comprise simulation testing and analysis that predicts (e.g., based on the supplied frequency and severity distributions) expected total losses (first parameter-based and/or second parameter-based) over time.

According to some embodiments, the method 400 may comprise determining an expense load, at 404. The pure premium determined at 402 does not take into account operational realities experienced by an insurer. The pure premium does not account, for example, for operational expenses such as overhead, staffing, taxes, fees, etc. Thus, in some embodiments, an expense load (or factor) is determined and utilized to take such costs into account when determining an appropriate premium to charge for an insurance product. According to some embodiments, the method 400 may comprise determining a risk load, at 406. The risk load is a factor designed to ensure that the insurer maintains a surplus amount large enough to produce an expected return for an insurance product.

According to some embodiments, the method 400 may comprise determining a total premium, at 408. The total premium may generally be determined and/or calculated by summing or totaling one or more of the pure premium, the expense load, and the risk load. In such a manner, for example, the pure premium is adjusted to compensate for real-world operating considerations that affect an insurer.

According to some embodiments, the method 400 may comprise grading the total premium, at 410. The total premium determined at 408, for example, may be ranked and/or scored by comparing the total premium to one or more benchmarks. In some embodiments, the comparison and/or grading may yield a qualitative measure of the total premium. The total premium may be graded, for example, on a scale of “A”, “B”, “C”, “D”, and “F”, in order of descending rank. The rating scheme may be simpler or more complex (e.g., similar to the qualitative bond and/or corporate credit rating schemes determined by various credit ratings agencies such as Standard & Poors' (S&P) Financial service LLC, Moody's Investment Service, and/or Fitch Ratings from Fitch, Inc., all of New York, N.Y.) of as is or becomes desirable and/or practicable. More details on one method for calculating and/or grading a premium are provided in commonly-assigned U.S. Pat. No. 7,330,820 entitled “PREMIUM EVALUATION SYSTEMS AND METHODS” which issued on Feb. 12, 2008, the premium calculation and grading concepts and descriptions of which are hereby incorporated by reference herein.

According to some embodiments, the method 400 may comprise outputting an evaluation, at 412. In the case that the results of the determination of the total premium at 408 are not directly and/or automatically utilized for implementation in association with an insurance product, for example, the grading of the premium at 410 and/or other data such as the risk score determined at 310 of FIG. 3 may be utilized to output an indication of the desirability and/or expected profitability of implementing the calculated premium. The outputting of the evaluation may be implemented in any form or manner that is or becomes known or practicable. One or more recommendations, graphical representations, visual aids, comparisons, and/or suggestions may be output, for example, to a device (e.g., a server and/or computer workstation) operated by an insurance underwriter and/or sales agent. One example of an evaluation comprises a creation and output of a risk matrix which may, for example, by developed utilizing Enterprise Risk Register® software which facilitates compliance with ISO 17799/ISO 27000 requirements for risk mitigation and which is available from Northwest Controlling Corporation Ltd. (NOWECO) of London, UK.

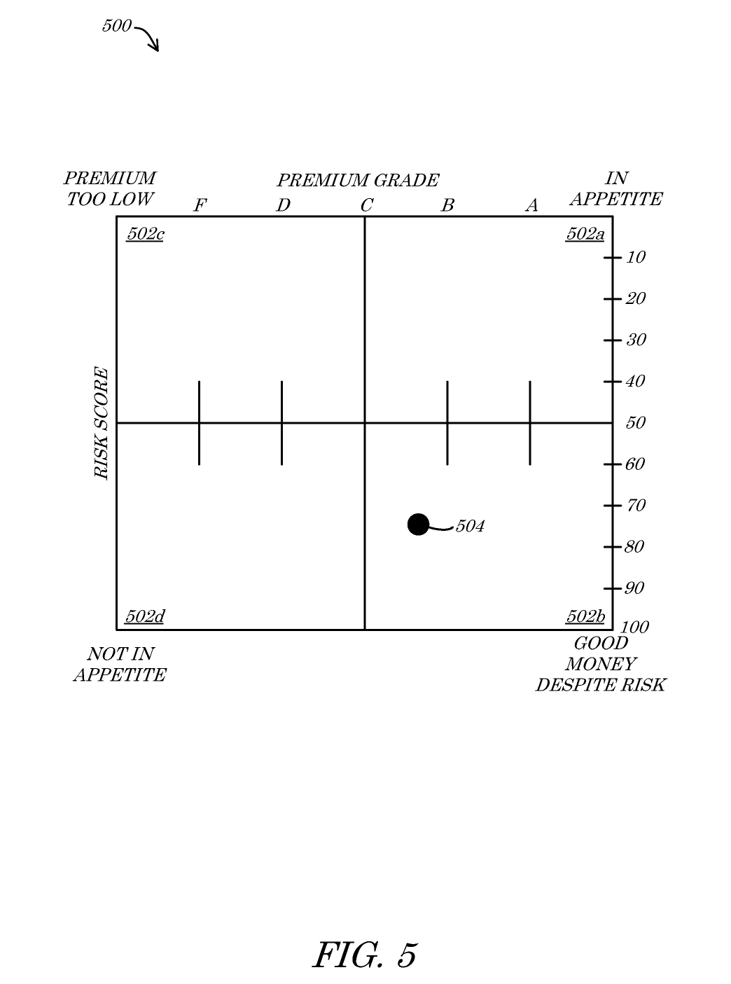

Referring to FIG. 5, for example, a diagram of an exemplary risk matrix 500 according to some embodiments is shown. In some embodiments (as depicted), the risk matrix 500 may comprise a simple two-dimensional graph having an X-axis and a Y-axis. Any other type of risk matrix, or no risk matrix, may be used if desired. The detail, complexity, and/or dimensionality of the risk matrix 500 may vary as desired and/or may be tied to a particular insurance product or offering. In some embodiments, the risk matrix 500 may be utilized to visually illustrate a relationship between the risk score (e.g., from 230 of FIG. 2 and/or from 310 of FIG. 3) of an object (and/or account and/or group of objects) and the total determined premium (e.g., from 240 of FIG. 2 and/or 408 of FIG. 4; and/or a grading thereof, such as from 410 of FIG. 4) for an insurance product offered in relation to the business and/or object (and/or account and/or group of objects). As shown in FIG. 5, for example, the premium grade may be plotted along the X-axis of the risk matrix 500 and/or the risk score may be plotted along the Y-axis of the risk matrix 500.

In such a manner, the risk matrix 500 may comprise four (4) quadrants 502a-d (e.g., similar to a “four-square” evaluation sheet utilized by automobile dealers to evaluate the propriety of various possible pricing “deals” for new automobiles). The first quadrant 502a represents the most desirable situations where risk scores are low and premiums are highly graded. The second quadrant 502b represents less desirable situations where, while premiums are highly graded, risk scores are higher. Generally, object-specific data that results in data points being plotted in either of the first two quadrants 502a-b is indicative of an object for which an insurance product may be offered on terms likely to be favorable to the insurer. The third quadrant 502c represents less desirable characteristics of having poorly graded premiums with low risk scores and the fourth quadrant 502d represents the least desirable characteristics of having poorly graded premiums as well as high risk scores. Generally, object-specific data that results in data points being plotted in either of the third and fourth quadrants 502c-d is indicative of an object for which an insurance product offering is not likely to be favorable to the insurer.

One example of how the risk matrix 500 may be output and/or implemented with respect to insurance data for an account and/or group of objects will now be described. Assume, for example, that a business insurance policy is desired by a client or consumer and/or that business insurance policy product is otherwise analyzed to determine whether such a policy would be beneficial for an insurer to issue. Typical risk metrics such as the gross receipts of the business and/or the business classification of the business may be utilized to produce expected loss frequency and loss severity distributions (such as determined at 306b and 308b of FIG. 3).

In some embodiments, first parameter metrics associated with the business, property, and/or account (i.e., the object(s) being insured), such as a geo-coded probability of wind damage, may also be utilized to produce expected wind damage loss frequency and loss severity distributions (such as determined at 306a and 308a of FIG. 3). According to some embodiments, singular loss frequency and loss severity distributions may be determined utilizing both typical risk metrics, as well as second parameter metrics (of the business/object being insured and/or of other associated objects, such as other properties belonging to the same account, sub-account, etc.).

In the case that the risk rating for the account is greater than a certain pre-determined magnitude (e.g., threshold), based on likelihood of loss due to operations in a particular business class for example, the risk score for the business and/or account may be determined to be relatively high, such as seventy-five (75) on a scale from zero (0) to one hundred (100), as compared to a score of fifty (50) for a second risk rating (e.g., a different business class). Other factors such as the loss history for the account/object(s) (and/or other factors) may also contribute to the risk score for the business, property, building/structure, consumer, account, and/or insurance product associated therewith.

The total premium calculated for a potential insurance policy offering covering the property/account/object(s) (e.g., determined at 408 of FIG. 4) may, to continue the example, be graded between “B” and “C” (e.g., at 410 of FIG. 4) or between “Fair” and “Average”. The resulting combination of risk score and premium rating may be plotted on the risk matrix 500, as represented by a data point 504 shown in FIG. 5. The data point 504, based on the risk score and the corresponding premium calculation, is plotted in the second quadrant 502b, in a position indicating that while the risk of insuring the business/property/account/object(s) is relatively high, the calculated premium is probably large enough to compensate for the level of risk. In some embodiments, an insurer may accordingly look favorably upon issuing such as insurance policy to the client to cover the business/property/account/object(s) in question and/or may consummate a sale of such a policy to the client/consumer (e.g., based on the evaluation output at 412 of FIG. 4, such a decision and/or sale may be made)

Referring now to FIG. 6, a block diagram of a system 600 according to some embodiments is shown. In some embodiments, the system 600 may comprise an insurance server 610 and/or an insurance interface 620. According to some embodiments, the insurance server 610 may comprise (e.g., be chronologically, programmatically, logically, physically, and/or functionally apportioned into) one or more of a process flow selector 610-1, a business classification engine 610-2, and/or a rating engine 620-3. In some embodiments, the insurance interface 620 may comprise (e.g., be chronologically, programmatically, logically, physically, and/or functionally apportioned into) one or more of a preliminary policy information screen 620-1, a policy information detail screen 620-2, a coverage screen 620-3, a quote summary screen 620-4, and/or an issuance screen 620-5.

According to some embodiments, any or all of the components 610, 610-1, 610-2, 610-3, 620, 620-1, 620-2, 620-3, 620-4, 620-5 of the system 600 may be similar in configuration and/or functionality to any similarly named and/or numbered components described herein. Fewer or more components 610, 610-1, 610-2, 610-3, 620, 620-1, 620-2, 620-3, 620-4, 620-5 (and/or portions thereof) and/or various configurations of the components 610, 610-1, 610-2, 610-3, 620, 620-1, 620-2, 620-3, 620-4, 620-5 may be included in the system 600 without deviating from the scope of embodiments described herein. The system 600 may comprise a single device, a combination of devices and/or components 610, 610-1, 610-2, 610-3, 620, 620-1, 620-2, 620-3, 620-4, 620-5, and/or a plurality of devices, as is or becomes desirable and/or practicable. Similarly, in some embodiments, one or more of the various components 610, 610-1, 610-2, 610-3, 620, 620-1, 620-2, 620-3, 620-4, 620-5 may not be needed and/or desired in the system 600. In some embodiments, the system 600 may be configured and/or utilized to implement and/or facilitate any of the methods 200, 300, 400, 1000 of FIG. 2, FIG. 3, FIG. 4, and/or FIG. 11 herein, or one or more portions and/or combinations thereof.

In some embodiments, the preliminary policy information screen 620-1 (and/or the insurance interface 620) may be provided to a user (not shown) in connection with the operation of the insurance server 610. The insurance server 610 may generate the insurance interface 620, for example, and/or may define and/or cause a generation of the insurance interface 620. The insurance interface 620 may, for example, be driven and/or generated by instructions and/or data sent from the insurance server 610 to one or more other devices (not shown in FIG. 6; such as one or more of the user devices 102a-n of FIG. 1). In some embodiments, the insurance interface 620 may be output by an application (not explicitly depicted in FIG. 6) that receives instructions and/or data from the insurance server 610.

According to some embodiments, the preliminary policy information screen 620-1 may comprise one or more data fields, forms, and/or input areas labeled and/or otherwise configured for entry of initial, basic, background, and/or preliminary policy information. Such information may comprise, for example, an indication of a desired policy effective date, an indication of a current date, an indication of a state or other jurisdiction in which the policy is desired, an indication of a policy type desired, etc. In some embodiments, preliminary policy information entered (e.g., by a user and/or via a user device not shown in FIG. 6) into and/or received by the preliminary policy information screen 620-1 (e.g., by the insurance interface 620) may be utilized by the process flow selector 610-1 of the insurance server 610. The process flow selector 610-1 may, for example, comprise a set of rules and/or logical programming steps that are configured to accept as inputs data from the preliminary policy information screen 620-1. According to some embodiments, the output of the process flow selector 610-1 may comprise an indication of an appropriate interface and/or rule set flow based on the preliminary information received via the preliminary policy information screen 620-1. The process flow selector 610-1 may, for example, trigger, define, and/or cause the output and/or generation of the policy information detail screen 620-2.

A user of the insurance interface 620 may, for example, select a button or command (not shown in FIG. 6) that triggers a call to the process flow selector 610-1 and/or causes an outputting of the policy information detail screen 620-2. The policy information detail screen 620-2 may, in some embodiments, comprise one or more data fields, forms, and/or input areas labeled and/or otherwise configured for entry of more detailed and/or additional policy information. Such information may comprise, for example, an indication of characteristics and/or attributes of a business to be insured (e.g., gross receipts, payroll, square footage of business operations, business location(s), etc.), geospatial data, third-party data descriptive of a business and/or location, etc. According to some embodiments, the policy information detail screen 620-2 may comprise and/or provide a plurality of business classification questions and/or underwriting questions (e.g., for which, answers may be received by the insurance server 610 via the policy information detail screen 620-2). In some embodiments, detailed policy information entered (e.g., by the user and/or via the user device) into and/or received by the policy information detail screen 620-2 (e.g., by the insurance interface 620) may be utilized by the business classification engine 610-2 of the insurance server 610. The business classification engine 610-2 may, for example, comprise a set of rules and/or logical programming steps that are configured to accept as inputs data from the policy information detail screen 620-2. According to some embodiments, the output of the business classification engine 610-2 may comprise an indication of a preliminary business classification, possible and/or applicable business classifications, business reclassification information, and/or business classification/reclassification tiebreaking information, any or all of which may be based (at least in part) on the detailed policy information received via the policy information detail screen 620-2. According to some embodiments, the business classification engine 610-2 may trigger, define, and/or cause the output and/or generation of the coverage screen 620-3 and/or may provide input to the rating engine 610-3.

In some embodiments for example, a user of the insurance interface 620 may select a button or command (not shown in FIG. 6) that triggers a call to the business classification engine 610-2 and/or causes an outputting of the coverage screen 620-3. The coverage screen 620-3 may, in some embodiments, comprise one or more data fields, forms, and/or input areas labeled and/or otherwise configured for entry and/or verification of data descriptive of one or more types, levels, and/or characteristics of insurance (and/or other underwriting) coverage that is desired. According to some embodiments, coverage information entered (e.g., by the user and/or via the user device) into and/or received by the coverage screen 620-3 (e.g., by the insurance interface 620) may be utilized by the rating engine 610-3 of the insurance server 610. The rating engine 610-3 may, for example, comprise a set of rules and/or logical programming steps that are configured to accept as inputs data from the coverage screen 620-3 and/or data from the business classification engine 610-2. According to some embodiments, the output of the rating engine 610-3 may comprise an indication of one or more of a risk rating and policy pricing information (e.g., premiums, deductibles, discounts, surcharges, fees), which may be based (at least in part) on the coverage information received via the coverage screen 620-3 (and/or the business classification/reclassification information (e.g., a final business classification resulting from a business classification tiebreaking selection processes) received from the business classification engine 610-2). According to some embodiments, the rating engine 610-3 may trigger, define, and/or cause the output and/or generation of the quote summary screen 620-4.

A user of the insurance interface 620 may, for example, select a button or command (not shown in FIG. 6) that triggers a call to the rating engine 610-3 and/or causes an outputting of the quote summary screen 620-4. The quote summary screen 620-4 may, in some embodiments, comprise data descriptive of one or more of a risk rating, policy pricing, coverage, limits, and/or other policy details descriptive of an insurance and/or other underwriting product offered to the user (e.g., agent, customer, client, potential customer, etc.) based on the information received from the user via the insurance interface 620 (and/or based on other information such as third-party and/or pre-stored data). In some embodiments, the quote summary screen 620-4 may comprise links and/or paths via which the user may proceed back to any or all of the preliminary policy information screen 620-1, the policy information detail screen 620-2, and/or the coverage screen 620-3 to verify, change, update, and/or otherwise edit and/or review data upon which an product quotation provided by the quote summary screen 620-4 is based. In such a manner, for example, the user may iteratively provide data via the insurance interface 620 and receive in response thereto (e.g., via the quote summary screen 620-4) an indication of a quote for an underwriting product such as a business insurance policy.

According to some embodiments, once the user is satisfied with the provided quote, product offering, and/or provided data, the user may select a button or command (not shown in FIG. 6) that triggers and/or causes an outputting of the issuance screen 620-5. The issuance screen 620-5 may, for example, provide finalized information regarding payment and/or execution of necessary documents and/or forms required for consummating an instance of the desired insurance product.

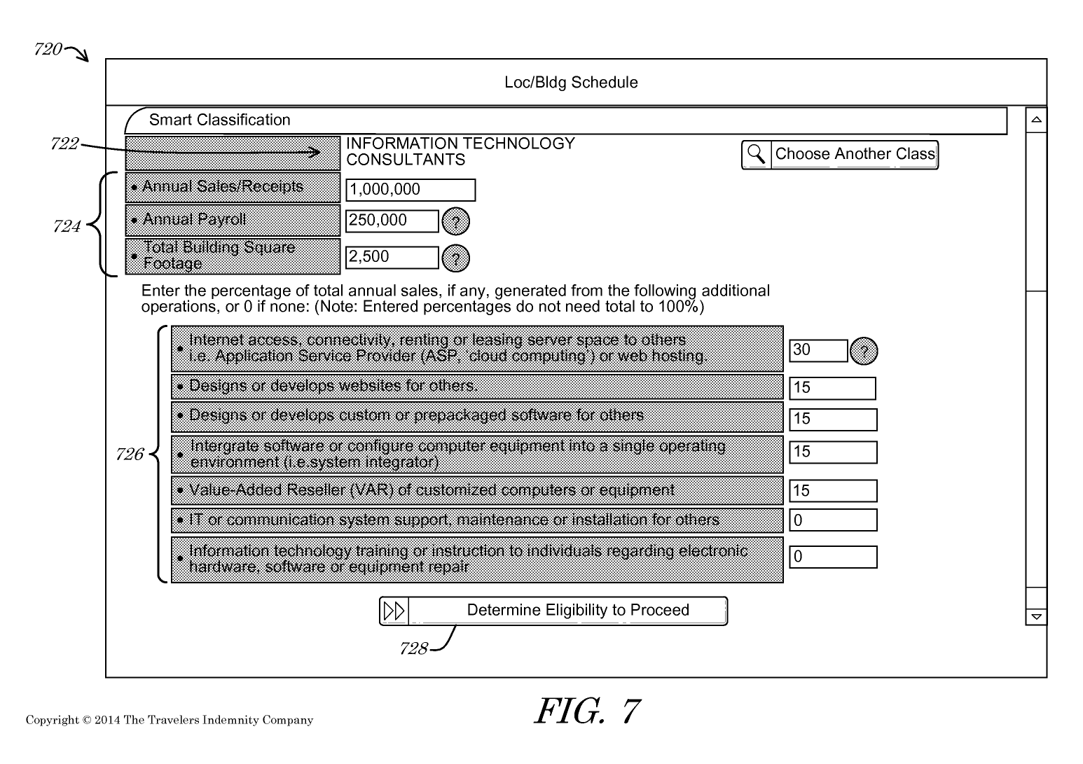

Turning now to FIG. 7, a diagram of an example interface 720 according to some embodiments is shown. In some embodiments, the interface 720 may comprise a web page, web form, database entry form, Application Programming Interface (API), spreadsheet, table, and/or application or other Graphical User Interface (GUI) via which an underwriter (or customer or other entity) may enter data to conduct and/or facilitate an underwriting and/or sales process. The interface 720 may, for example, comprise a front-end of an underwriting program and/or platform programmed and/or otherwise configured to execute, conduct, and/or facilitate any of the various methods 300, 400, 500, 1000 of FIG. 3, FIG. 4, FIG. 5, and/or FIG. 10 herein, and/or portions or combinations thereof. In some embodiments, the interface 720 may be output via a computerized device such as one or more of the user devices 102a-n and/or the controller device 110 or the insurance server 610, of FIG. 1 and/or FIG. 6 herein. In some embodiments, the interface 720 may comprise an exemplary instance of the policy information detail screen 620-2 of the interface 620 of FIG. 6 herein.

According to some embodiments, the interface 720 may comprise one or more tabs and/or other segmented and/or logical-presented data forms and/or fields. In some embodiments, the interface 720 may be configured and/or organized to allow and/or facilitate entry of detailed and/or specific information regarding a business, policy, customer account (and/or potential customer account). As depicted, for example, an area (e.g., one or more data entry mechanisms, tools, objects, and/or features) may be provided that outputs an indication of a “smart classification” 722 and/or an area may be provided that provides for entry/editing of policy data 724 descriptive of a business, an account, policy, and/or product. The smart classification 722 may comprise, for example, an automatically-determined business classification for the business, such as may be based on a query of third-party business classification data stored in relation to geospatial location information. According to some embodiments, the smart classification 722 may be at least partially based on business-identifying information received prior to a providing of the interface 720—e.g., from the preliminary policy information screen 620-1 of the insurance interface 620 of FIG. 6. A business name, customer name, and/or associated business and/or customer address, may for example, be utilized to automatically generate (e.g., in the absence of receiving user input defining a business classification for the business) and/or pre-populate the smart classification 722. As depicted solely for exemplary purposes in FIG. 7, the automatically-assigned and/or derived business classification (or initial or preliminary business classification) is “Information Technology Consultants”.

In some embodiments, the policy data 724 may comprise any business, property, account, and/or policy data that is or becomes known or practicable. As depicted for exemplary purposes in FIG. 7, the policy data 724 may comprise data defining annual sales/receipts for the business to be insured, annual payroll for the business, and total building square footage for the business. According to some embodiments, the interface 720 may comprise business classification question fields 726. The business classification question fields 726, in some embodiments, may comprise any type, quantity, and/or configuration of data fields regarding business and/or underwriting questions, rules, parameters, and/or guidelines. The business classification question fields 726 may, as depicted for example, comprise information descriptive of questions configured to obtain information directed to the business type of the insured. According to some embodiments, and as depicted, the business classification question fields 726 may comprise one or more input areas configured to receive answers to the listed business classification/underwriting questions. In the depicted example, a user has provided a plurality of answers indicating that fifteen percent (15%) of the business's annual sales are categorized in accordance with the associated and respective business classification questions indicated by the business classification question fields 726. In some embodiments, one or more of the business classification question fields 726 may be pre-associated with and/or assigned or related to a plurality of possible business classifications.

In such embodiments, automatic business classification may advantageously include the business classification tiebreaking as described herein. As depicted in FIG. 7, for example, the first two questions (and answers) of the business classification question fields 726 may correspond to a first business classification (e.g., “Website Design Services”), while the third through fifth questions (and answers) of the business classification question fields 726 may correspond to a second business classification (e.g., “Software Development and Programming Services”). According to some embodiments, the sum or accumulation of answers relating to each particular business classification may be determined and/or compared. In some embodiments, such as in accordance with the exemplary numeric answers depicted in FIG. 7, the sum of the values for the answers corresponding to the first business classification (e.g., forty-five (45) for the first two answers) may equal the sum of the values for the answers corresponding to the second business classification (e.g., forty-five (45) for the third through the fifth answers)—i.e., a “tie”. In other words, a plurality of business classifications (e.g., the first and second business classifications (or reclassifications)) may be determined to be applicable to and/or appropriately associated with a particular business, account, policy, user, etc. In such cases, business classification/reclassification tiebreaking may be desired or necessary.

According to some embodiments, the interface 720 may comprise an eligibility button 728. The eligibility button 728 may, upon triggering and/or receipt of input from the user (e.g., a properly-positioned click of a mouse) for example, trigger a business reclassification routine and/or processes. The output of such a process may, in some embodiments, alter the preliminary and/or initial business classification of “Information Technology Consultants”, based on the business classification question fields 726 (and/or input and/or answers received therefrom), to a final business classification (not shown in FIG. 7). In the case that multiple business classifications are indicated by the answers to the business classification questions, a tiebreaking process, as described herein, may be initiated to determine the final business classification for the business.

While various components of the interface 720 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning now to FIG. 8A and FIG. 8B, an example data storage structure 840 according to some embodiments is shown. In some embodiments, the data storage structure 840 may comprise a plurality of data tables, such as an underwriting question data table 844a and/or a business classification tiebreaking data table 844b. The data tables 844a-b may, for example, be utilized (e.g., in accordance with the method 1000 of FIG. 10 herein) to store, determine, and/or utilize business and/or insurance policy (e.g., customer) data (e.g., provided by a user device 102a-n of FIG. 1), such as to classify, reclassify, and/or perform business classification/reclassification tiebreaking, as described herein with respect to business classification processes.

The underwriting question data table 844a may comprise, in accordance with some embodiments, an underwriting question Identifier (ID) field 844a-1, an underwriting question field 844a-2, a business class ID field 844a-3, a business class name field 844a-4, and/or a gate field 844a-5. Any or all of the number and/or ID fields (e.g., the underwriting question ID field 844a-1 and/or the business class ID field 844a-3) described herein may generally store any type of identifier that is or becomes desirable or practicable (e.g., a unique identifier, an alphanumeric identifier, and/or an encoded identifier). According to some embodiments, the underwriting question data table 844a may generally store data that relates underwriting and/or business classification questions and/or answers to one or more business classification types. In such a manner, for example, answers to such questions may be utilized to identify appropriate and/or possible business classifications associated with a particular business.

In some embodiments, the underwriting question field 844a-2 may store data indicative of a particular underwriting and/or business classification question, query, and/or informational statement. Such questions may be provided to and/or asked of a user, for example, to solicit information that facilitates automatic business classification processes. According to some embodiments, the business class ID field 844a-3 and the business class name field 844a-4 may store identifying formation for business classifications assigned, related, and/or attached to the particular underwriting and/or business classification questions. In some embodiments, such as for IT services businesses as described herein, an underwriting/business classification question may be associated with a plurality of business classes. As depicted in the example data of FIG. 8A, for example, the question identified as “UW-VER2-0093” is associated with (e.g., has a pre-stored data relation to) both a “SOFTWARE DEVELOPMENT AND PROGRAMMING SERVICES” business class as well as a “API PROGRAMMING SERVICES” business class. In such embodiments, a business class tiebreaking process may be implemented to choose, from the two (or more) possible/applicable/appropriate business classes, a final business classification/reclassification (as described in more detail with respect to FIG. 8B).

According to some embodiments, the gate field 844a-5 may store information indicative of a criteria, threshold, or “gate” that defines when and/or how a particular underwriting question and/or answer thereto may be considered an indication of a particular associated business class. As depicted for exemplary purposes only, for example, the first underwriting question identified as “UW-VER1-2933” may only be considered to indicate the associated business class in the case that more than ten percent (10%) of a particular metric is indicated in response to the underwriting question. In the case that the question requests an indication as to what percentage of a business's gross receipts correspond to the substance of the underwriting question, for example, only answers in excess of ten percent (10%) of gross receipts will trigger an indication that the business class “WEBSITE DESIGN OR SERVICES INCLUDING ASPS OR WEB HOSTING” is appropriately associated with the business in question. As depicted, other “gates” or thresholds for answers to the questions may also or alternatively be implemented, such as thresholds or criteria based on scores, ranks, Boolean operators, qualitative descriptors, ranges, and/or classes, etc. According to some embodiments, such as in the case that answers to questions are scored and compared to determine one or more applicable business classifications, thresholds such as implemented by the gate field 844a-5 may not be necessary or desired.

In some embodiments, the business classification tiebreaking data table 844b may comprise a business class ID field 844b-1, a business class name field 844b-2, and/or a score field 844b-3. According to some embodiments, the business classification tiebreaking data table 844b may store a record (and associated business class identifier and name) for each known or applicable business classification. The score field 844b-3 may, in some embodiments, store a value of a metric, parameter, and/or variable that is utilized to conduct business classification and/or reclassification tiebreaking. The score field 844b-3 may, for example, store a ranking among the listed business classifications (and/or a portion or group of the business classifications). According to some embodiments, such a ranking may be determined (e.g., calculated or looked-up) based on risk rating data and/or risk data. Business classes may be ranked, for example, based on a relative (e.g., among other business classifications in the same data set or group) risk and/or loss factors, such as probability of loss, magnitude of probable loss, etc. In such a manner, in the case that an automatic business classification routine or procedure and/or an automatic reclassification routine or procedure (e.g., based on and/or utilizing some or all of the underwriting questions stored in the underwriting question data table 844a) results in a plurality of possible and/or appropriate initial business classifications or reclassifications, the score field 8444b-3 may be queried to determine which of the plurality of “tied” business classes has the highest ranking (e.g., highest risk score, ranking, level, etc.). The score field 844b-3 may, in some embodiments, store a ranking (e.g., from one (1) to ten (10)—or from one (1) to the “n^{th}” business class), a score (e.g., one (1) to one hundred (100)), a rating (e.g., “AA”, “B”, “high”, “low”), and/or any other type and/or combination of qualitative and/or quantitative value. In some embodiments, the business class with the highest rank/score/rating may be selected as the “final” business classification and/or reclassification—e.g., the one of the plurality of applicable and/or appropriate “initial” business classes that ‘breaks the tie’.

According to some embodiments, a relationship may be established between the underwriting question data table 844a and the business classification tiebreaking data table 844b. In some embodiments, the relationship may be defined by utilizing the business class ID field 844b-1 as a data key linking to the business class ID field 844a-3. According to some embodiments, the relationship may comprise any type of data relationship that is or becomes desirable, such as a one-to-many, many-to-many, or many-to-one relationship. In the case that multiple business classes are likely to be indicated by more than one underwriting/business classification question, the relationship may comprise a many-to-one relationship (e.g., many business classes per single underwriting question. In such a manner, for example, underwriting questions may be associated and/or linked with one or more appropriate business classifications and/or business classifications associated with underwriting questions may be readily compared, contrasted, scored, ranked, sorted, etc.

In some embodiments, fewer or more data fields than are shown may be associated with the example data storage structure 840 and/or the example data tables 844a-b. Only a portion of one or more databases and/or other data stores is necessarily shown in any of FIG. 8A and/or FIG. 8B, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein nor imply that any such data is accurate.

According to some embodiments, systems, methods, and articles of manufacture described herein may be utilized to gather insurance and/or business classification data, form, identify, define, and/or otherwise determine relationships between the various data, and/or utilize such data (e.g., business classification, reclassification, and/or tiebreaking data) to inform or facilitate various processes and/or perform various tasks as described herein.

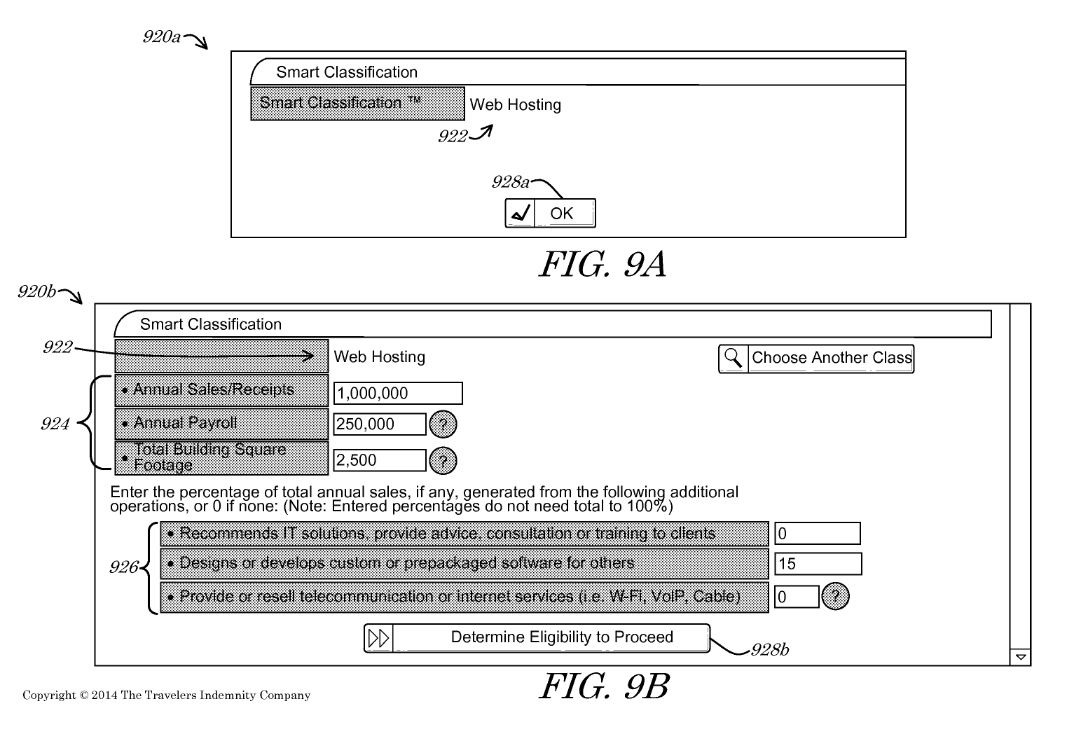

Turning now to FIG. 9A and FIG. 9B, diagrams of example interfaces 920a-b according to some embodiments are shown. In some embodiments, the interfaces 920a-b may comprise one or more web pages, web forms, database entry forms, API objects, spreadsheets, tables, and/or applications or other GUI objects via which an underwriter (or customer or other entity) may enter data to conduct and/or facilitate an underwriting and/or sales process. The interfaces 920a-b may, for example, comprise a front-end of an underwriting program and/or platform programmed and/or otherwise configured to execute, conduct, and/or facilitate any of the various methods 300, 400, 500, 1000 of FIG. 3, FIG. 4, FIG. 5, and/or FIG. 10 herein, and/or portions or combinations thereof. In some embodiments, the interfaces 920a-b may be output via a computerized device such as one or more of the user devices 102a-n and/or the controller device 110 or the insurance server 610, of FIG. 1 and/or FIG. 6 herein. In some embodiments, the interfaces 920a-b may comprise an exemplary instance of the policy information detail screen 620-2 of the interface 620 of FIG. 6 herein and/or may be related to the interface 720 of FIG. 7. The interfaces 920a-b may, for example, comprise different and/or subsequent pages/forms/pop-ups that are portions of the same interface-flow as the interface 720.

According to some embodiments, a first example interface 920a may comprise a pop-up screen display (e.g., screen output) that is provided and/or output after an answering of one or more of the business or underwriting question represented by the business classification fields 726 of the example interface 720 of FIG. 7. In some embodiments, the first example interface 920a may be generated and/or triggered upon, after, and/or in response to an activation of the eligibility button 728 of the example interface 720. In accordance with some embodiments, for example, insurance/policy data may be entered into the example interface 720 of FIG. 7, followed by a providing (and attendant receiving; e.g., by the interface 720) of answers to the business classification/underwriting questions, followed by a selection of the eligibility button 728. The eligibility button 728 may, as described, may trigger and/or call an automatic business classification and/or reclassification process (e.g., classification in the case that the smart classification 722 has not yet occurred and/or is empty, and reclassification in the case that the smart classification 722 has already occurred and/or is populated). Once an automatic business classification or reclassification has occurred, the first interface 920a may be provided, notifying a user that a final business classification 922 (or reclassification) of their business has occurred (reclassification is shown in FIG. 9A for exemplary purposes). According to some embodiments, the final business classification 922 may be the result of an automatic business reclassification tiebreaking process as described herein (e.g., may be based, at least partially, on the data stored in the score field 844b-3 of the business classification tiebreaking data table 844b of FIG. 8B herein).

In some embodiments, the first interface 920a may comprise an advancement button 928a such as the depicted “OK” button, a “continue” button, or the like. According to some embodiments, selection and/or activation of the advancement button 928a may trigger and/or call a second example interface 920b.

According to some embodiments, a second example interface 920b may comprise one or more tabs and/or other segmented and/or logical-presented data forms and/or fields. In some embodiments, the second interface 920b may be configured and/or organized to allow and/or facilitate entry of detailed and/or specific information regarding a business, policy, customer account (and/or potential customer account). As depicted, for example, an area (e.g., one or more data entry mechanisms, tools, objects, and/or features) may be provided that outputs an indication of the final business classification 922 and/or an area may be provided that provides for entry/editing of policy data 924 descriptive of the business, the account, policy, and/or product. According to some embodiments, the second interface 920a may comprise business classification question fields 926. The business classification question fields 926 may, for example, comprise newly-selected questions and/or updated versions of the questions presented by the business classification fields 726 of FIG. 7. In some embodiments, the business classification question fields 926 may be selected based on the final business classification 922. The result of a an automatic business classification/reclassification tiebreaking process, for example, may be utilized to select, generate, and/or otherwise determine one or more questions to present to the user via the business classification question fields 926.

According to some embodiments, the second interface 920 may comprise an eligibility button 928b. The eligibility button 928b may, upon triggering and/or receipt of input from the user (e.g., a properly-positioned click of a mouse) for example, trigger a second business classification or reclassification routine and/or processes. In some embodiments, activation of the eligibility button 928b may cause the second interface 920b to be replaced and/or superseded by a different interface (not shown in FIG. 7), such as the coverage screen 620-4 of FIG. 6.

While various components of the interfaces 920a-b have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning now to FIG. 10, a flow diagram of a method 1000 according to some embodiments is shown. In some embodiments, the method 1000 may be implemented, facilitated, and/or performed by or otherwise associated with the systems 100, 600 of FIG. 1 and/or FIG. 6 herein (and/or portions thereof, such as the controller device 110). In some embodiments, the method 1000 may be associated with the methods 200, 300, 400 of FIG. 2, FIG. 3, and/or FIG. 4. The method 1000 may, for example, comprise one or more portions of the method 200 such as the insurance data processing 210, the insurance underwriting 220 (and/or the risk assessment 230 and/or premium calculation 240 thereof), and/or the insurance policy quote and issuance 250. In some embodiments, the method 1000 may be illustrative of an automatic business classification/reclassification tiebreaking processes as described herein.

According to some embodiments, the method 1000 may comprise receiving (e.g., by a processing device, from a user device, and/or via an electronic communications network) business information, at 1002. An insurance agent, broker, and/or insurance provider or underwriter server and/or other electronic device may, for example, receive one or more signals indicative of data descriptive of a particular business. Insurance data 202a-n of FIG. 2 may, in some embodiments, be received via the policy information detail screen 620-2. According to some embodiments, the business information may comprise business location information (e.g., address, coordinates), business identification information (e.g., a business or tax ID, business name, trademark), and/or business attribute and/or characteristic information (e.g., sales, revenue, profit, market capitalization, debt, workplace square footage, workforce data).

In some embodiments, the method 1000 may comprise determining (e.g., by the processing device) an initial business classification, at 1004. The business information received at 1002 may, for example, be utilized to conduct one or more queries to third-party databases and/or information services, such as to conduct a “smart classification”, as described in co-pending U.S. patent application Ser. No. 13/179,464 filed on Jul. 8, 2011 and titled “SYSTEMS AND METHODS FOR BUSINESS CLASSIFICATION”, the business classification concepts and descriptions of which are already incorporated by reference herein. In some embodiments, the initial business classification may comprise a selection and/or determination of a business class applicable to a particular business, such as based on business location data. According to some embodiments, the initial business classification (e.g., determined automatically and/or without business classification input from a user/customer) may be provided and/or output to a user, such as via the smart classification 722 of the interface 722 of FIG. 7. In some embodiments, such as in the case that the automatic or “smart” classification results in a plurality of possible and/or applicable or appropriate business classes, the method 1000 may proceed to perform a tiebreaking process, such as at 1012 (such processes flow link not shown in FIG. 10). In the case that the automatic business classification results in a single applicable business class however, the method 1000 may proceed to 1006.

According to some embodiments for example, the method 1000 may comprise providing (e.g., by the processing device, to the user device, and/or via the electronic communications network) business classification questions, at 1006. Business classification and/or underwriting questions such as those represented by the business classification question fields 726, 926 of the interfaces 720, 920b of FIG. 7 and/or FIG. 9B and/or as stored in the underwriting questions field 844a-2 of the underwriting questions table 844a of FIG. 8A may, for example, be provided and/or output to the user. According to some embodiments, such questions may be based on the initial business classification at 1004. The business classification/underwriting questions may, for example, be selected, generated, and/or worded to elicit responses that are likely to be beneficial in determining which of a plurality of similar business classes a business may actually be most appropriately classified in.

In some embodiments, the method 1000 may comprise receiving (e.g., by the processing device, from the user device, and/or via the electronic communications network) answers to the business classification questions, at 1008. Answers to the questions provided and/or output at 1106, for example, may be received via an interface such as via the business classification question fields 726, 926 of the interfaces 720, 920b of FIG. 7 and/or FIG. 9B. As depicted for exemplary purposes in FIG. 7, such answers may indicate that the business in question (e.g., a business for which an insurance policy is sought) realizes approximately fifteen percent (15%) of annual sales in accordance with each of the first five (5) listed questions and/or business class indicators or descriptions.

According to some embodiments, the method 1000 may comprise determining (e.g., by the processing device) a business reclassification tie, at 1010. Based on the answers received at 1008, for example, a plurality of possible (e.g., applicable, such as based on the answers) business reclassifications may be identified, such as via a query to one or more databases and/or tables. The underwriting question data table 844a may be accessed, for example, to determine (e.g., utilizing the gate field 844a-3) whether any particular answer indicates one or more particular business classes. As described herein, particularly with respect to certain business types such as the IT services industry, certain questions and/or answers may indicate a plurality of possible, appropriate, and/or applicable business classes. In other words, business classifications that are deemed appropriate based on the answers may have the same score, value, rank, class, and/or other equivalent metric, defining a “tie” therebetween. In such cases, the method 1000 may continue to 1012 to conduct a business classification/reclassification tiebreaking procedure.

In some embodiments for example, the method 1000 may comprise conducting (e.g., by the processing device) business reclassification tiebreaking, at 1012. Tiebreaking may comprise, for example, selecting (e.g., by the processing device) a final business reclassification from among the plurality of identified possible and/or applicable business reclassifications (or classifications, as the case may be). The determination and/or selection of a final business classification may, for example, be termed a “tiebreaking” processes or procedure. According to some embodiments, one of the plurality of possible business reclassifications from 1010 may be selected as the final business classification. In some embodiments, each of the plurality of possible business reclassifications may be ranked, scored, sorted and/or otherwise filtered and/or compared to determine the final business classification. A database and/or data table such as the business classification tiebreaking data table 844b of FIG. 8B may, for example, be queried to determine scores, ranks, and/or other comparative metrics for each business class of the plurality of possible business reclassifications. In some embodiments, such as in the case that the score field 844b-3 of the business classification tiebreaking data table 844b is utilized, pre-stored scores and/or ranks for each of the possible business reclassifications may be queried and/or compared. According to some embodiments, the single possible business classification with the highest stored rank or score may be automatically selected. In the case that such ranks or scores are based on risk metrics, selection of the highest-ranking/scoring business classification (from the plurality of possible choices) may result in a selection of the business classification with the highest risk rating of the group. In such a manner, for example, in the case that multiple business classifications may be possible for a business, the most conservative choice (on the part of the underwriter/insurance provider) of the possible class with the highest risk, may be selected. In some embodiments, the score and/or ranks may be weighted and/or grouped. Ranks and/or scores may be weighted based on the answers provided at 1008, for example. Each entered business annual sales percentage entered in the interface 720 of FIG. 7, for example, may be multiplied by a respective business class score for an associated business class to achieve and/or define a weighted business classification tiebreaking metric. Such metric may then be utilized to select the final business classification (e.g., based on stored selection rules). In some embodiments, the scores/ranks may be based on other data and/or parameters in addition to and/or instead of risk metrics, such as location data, demographic data, timing data, etc.

According to some embodiments, the method 1000 may comprise determining (e.g., by the processing device) an insurance product, at 1014. Based on the business information received at 1002, for example, a software program and/or computerized processing device may look-up, search, identify, calculate, and/or otherwise determine one or more available policy types. According to some embodiments, the customer and/or underwriter may choose, select, and/or identify one or more desired policy types. An interface may be utilized, for example, to select a desired policy type from a drop-down menu of available underwriting products. Such a menu of available product and/or policy types may, in some embodiments, be populated based on the determination of the final business classification at 1012. In some embodiments, policy type selection may comprise a walk-through or “wizard” including questions configured and/or selected to assist a customer (and/or underwriter/distributor) in selecting an appropriate policy type based on the final business classification, desired coverage, benefits, results, etc. In some embodiments, a computerized processing device such as a PC or computer server and/or a software program and/or interface may receive the policy type selection and/or one or more indications thereof (e.g., for use in policy pricing and/or sales, as described herein).

Turning to FIG. 11, a block diagram of an apparatus 1110 according to some embodiments is shown. In some embodiments, the apparatus 1110 may be similar in configuration and/or functionality to any of the controller device 110, the user devices 102a-n, and/or the third-party device 106, all of FIG. 1 herein, and/or the insurance server 610 of FIG. 6 herein. The apparatus 1110 may, for example, execute, process, facilitate, and/or otherwise be associated with the methods 200, 300, 400, 1000 of FIG. 2, FIG. 3, FIG. 4, and/or FIG. 10 herein, and/or portions or combinations thereof. In some embodiments, the apparatus 1110 may comprise a processing device 1112, an input device 1114, an output device 1116, a communication device 1118, an interface 1120, a memory device 1140 (storing various programs and/or instructions 1142 and data 1144), and/or a cooling device 1150. According to some embodiments, any or all of the components 1112, 1114, 1116, 1118, 1120, 1140, 1142, 1144, 1150 of the apparatus 1110 may be similar in configuration and/or functionality to any similarly named and/or numbered components described herein. Fewer or more components 1112, 1114, 1116, 1118, 1120, 1140, 1142, 1144, 1150 and/or various configurations of the components 1112, 1114, 1116, 1118, 1120, 1140, 1142, 1144, 1150 be included in the apparatus 1110 without deviating from the scope of embodiments described herein.

According to some embodiments, the processor 1112 may be or include any type, quantity, and/or configuration of processor that is or becomes known. The processor 1112 may comprise, for example, an Intel® IXP 2800 network processor or an Intel® XEON™ Processor coupled with an Intel® E7501 chipset. In some embodiments, the processor 1112 may comprise multiple inter-connected processors, microprocessors, and/or micro-engines. According to some embodiments, the processor 1112 (and/or the apparatus 1110 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1110 comprises a server such as a blade server, necessary power may be supplied via a standard AC outlet, power strip, surge protector, and/or Uninterruptible Power Supply (UPS) device.

In some embodiments, the input device 1114 and/or the output device 1116 are communicatively coupled to the processor 1112 (e.g., via wired and/or wireless connections and/or pathways) and they may generally comprise any types or configurations of input and output components and/or devices that are or become known, respectively. The input device 1114 may comprise, for example, a keyboard that allows an operator of the apparatus 1110 to interface with the apparatus 1110 (e.g., by a consumer and/or agent, such as to price and/or purchase (or sell) insurance policies priced based on a business classification selected via tiebreaking as described herein, and/or by an underwriter and/or insurance agent, such as to evaluate risk and/or calculate premiums for an insurance policy, e.g., based a business classification selected via tiebreaking as described herein). In some embodiments, the input device 1114 may comprise a sensor configured to provide information such as encoded location, business identification, and/or risk data to the apparatus 1110 and/or the processor 1112. The output device 1116 may, according to some embodiments, comprise a display screen and/or other practicable output component and/or device. The output device 1116 may, for example, provide an interface (such as the interface 1120 and/or the interfaces 720, 920a-b of FIG. 7, FIG. 9A, and/or FIG. 9B herein) via which insurance and/or investment pricing, claims, and/or risk analysis are provided to a potential client (e.g., via a website) and/or to an underwriter, claim handler, or sales agent attempting to structure an insurance (and/or investment) product and/or investigate an insurance claim (e.g., via a computer workstation). According to some embodiments, the input device 1114 and/or the output device 1116 may comprise and/or be embodied in a single device such as a touch-screen monitor.

In some embodiments, the communication device 1118 may comprise any type or configuration of communication device that is or becomes known or practicable. The communication device 1118 may, for example, comprise a Network Interface Card (NIC), a telephonic device, a cellular network device, a router, a hub, a modem, and/or a communications port or cable. In some embodiments, the communication device 918 may be coupled to provide data to a client device, such as in the case that the apparatus 1110 is utilized to price and/or sell underwriting products (e.g., based at least in part on a business classification selected via tiebreaking as described herein). The communication device 1118 may, for example, comprise a cellular telephone network transmission device that sends signals indicative of selected business reclassifications (e.g., based on tiebreaking) to a remote device (e.g., of a user device). According to some embodiments, the communication device 1118 may also or alternatively be coupled to the processor 1112. In some embodiments, the communication device 1118 may comprise an IR, RF, Bluetooth™, Near-Field Communication (NFC), and/or Wi-Fi® network device coupled to facilitate communications between the processor 1112 and another device (such as a client device and/or a third-party device, not shown in FIG. 11).

The memory device 1140 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1140 may, according to some embodiments, store one or more of reclassification tiebreaking instructions 1142-1, risk assessment instructions 1142-2, underwriting instructions 1142-3, premium determination instructions 1142-4, client data 1144-1, business reclassification data 1144-2, underwriting data 1144-3, and/or claim/loss data 1144-4. In some embodiments, the reclassification tiebreaking instructions 1142-1, risk assessment instructions 1142-2, underwriting instructions 1142-3, premium determination instructions 1142-4 may be utilized by the processor 1112 to provide output information via the output device 1116 and/or the communication device 1118.

According to some embodiments, the reclassification tiebreaking instructions 1142-1 may be operable to cause the processor 1112 to process the client data 1144-1, business reclassification data 1144-2, underwriting data 1144-3, and/or claim/loss data 1144-4 in accordance with embodiments as described herein. Client data 1144-1, business reclassification data 1144-2, underwriting data 1144-3, and/or claim/loss data 1144-4 received via the input device 1114 and/or the communication device 1118 may, for example, be analyzed, sorted, filtered, decoded, decompressed, ranked, scored, plotted, and/or otherwise processed by the processor 1112 in accordance with the reclassification tiebreaking instructions 1142-1. In some embodiments, client data 1144-1, business reclassification data 1144-2, underwriting data 1144-3, and/or claim/loss data 1144-4 may be fed by the processor 1112 through one or more mathematical and/or statistical formulas and/or models in accordance with the reclassification tiebreaking instructions 1142-1 to identify a plurality of possible business classifications and/or reclassifications and/or select a final business classification or reclassification based on business classification tiebreaking, as described herein.

In some embodiments, the risk assessment instructions 1142-2 may be operable to cause the processor 1112 to process the client data 1144-1, business reclassification data 1144-2, underwriting data 1144-3, and/or claim/loss data 1144-4 in accordance with embodiments as described herein. Client data 1144-1, business reclassification data 1144-2, underwriting data 1144-3, and/or claim/loss data 1144-4 received via the input device 1114 and/or the communication device 1118 may, for example, be analyzed, sorted, filtered, decoded, decompressed, ranked, scored, plotted, and/or otherwise processed by the processor 1112 in accordance with the risk assessment instructions 1142-2. In some embodiments, client data 1144-1, business reclassification data 1144-2, underwriting data 1144-3, and/or claim/loss data 1144-4 may be fed by the processor 1112 through one or more mathematical and/or statistical formulas and/or models in accordance with the risk assessment instructions 1142-2 to inform and/or affect risk assessment processes and/or decisions in relation to business classification/reclassification tiebreaking, as described herein.

According to some embodiments, the underwriting instructions 1142-3 may be operable to cause the processor 1112 to process the client data 1144-1, business reclassification data 1144-2, underwriting data 1144-3, and/or claim/loss data 1144-4 in accordance with embodiments as described herein. Client data 1144-1, business reclassification data 1144-2, underwriting data 1144-3, and/or claim/loss data 1144-4 received via the input device 1114 and/or the communication device 1118 may, for example, be analyzed, sorted, filtered, decoded, decompressed, ranked, scored, plotted, and/or otherwise processed by the processor 1112 in accordance with the underwriting instructions 1142-3. In some embodiments, client data 1144-1, business reclassification data 1144-2, underwriting data 1144-3, and/or claim/loss data 1144-4 may be fed by the processor 1112 through one or more mathematical and/or statistical formulas and/or models in accordance with the underwriting instructions 1142-3 to cause, facilitate, inform, and/or affect underwriting product determinations and/or sales (e.g., based at least in part business classification/reclassification tiebreaking) as described herein.

In some embodiments, the premium determination instructions 1142-4 may be operable to cause the processor 1112 to process the client data 1144-1, business reclassification data 1144-2, underwriting data 1144-3, and/or claim/loss data 1144-4 in accordance with embodiments as described herein. Client data 1144-1, business reclassification data 1144-2, underwriting data 1144-3, and/or claim/loss data 1144-4 received via the input device 1114 and/or the communication device 1118 may, for example, be analyzed, sorted, filtered, decoded, decompressed, ranked, scored, plotted, and/or otherwise processed by the processor 1112 in accordance with the premium determination instructions 1142-4. In some embodiments, client data 1144-1, business reclassification data 1144-2, underwriting data 1144-3, and/or claim/loss data 1144-4 may be fed by the processor 1112 through one or more mathematical and/or statistical formulas and/or models in accordance with the premium determination instructions 1142-4 to cause, facilitate, inform, and/or affect underwriting product premium determinations and/or sales (e.g., based at least in part business classification/reclassification tiebreaking) as described herein.

In some embodiments, the apparatus 1110 may function as a computer terminal and/or server of an insurance and/or underwriting company, for example, that is utilized to rate, price, quote, sell, and/or otherwise offer underwriting products such as insurance plans (e.g., based at least in part business classification/reclassification tiebreaking). In some embodiments, the apparatus 1110 may comprise a web server and/or other portal (e.g., an Interactive Voice Response Unit (IVRU)) that provides VED-based claim and/or underwriting product determinations and/or products to clients, such as via the interface 1120.

In some embodiments, the apparatus 1110 may comprise the cooling device 1150. According to some embodiments, the cooling device 1150 may be coupled (physically, thermally, and/or electrically) to the processor 1112 and/or to the memory device 1140. The cooling device 1150 may, for example, comprise a fan, heat sink, heat pipe, radiator, cold plate, and/or other cooling component or device or combinations thereof, configured to remove heat from portions or components of the apparatus 1110.

Any or all of the exemplary instructions and data types described herein and other practicable types of data may be stored in any number, type, and/or configuration of memory devices that is or becomes known. The memory device 1140 may, for example, comprise one or more data tables or files, databases, table spaces, registers, and/or other storage structures. In some embodiments, multiple databases and/or storage structures (and/or multiple memory devices 1140) may be utilized to store information associated with the apparatus 1110. According to some embodiments, the memory device 1140 may be incorporated into and/or otherwise coupled to the apparatus 1110 (e.g., as shown) or may simply be accessible to the apparatus 1110 (e.g., externally located and/or situated).

Referring to FIG. 12A, FIG. 12B, FIG. 12C, FIG. 12D, and FIG. 12E, perspective diagrams of exemplary data storage devices 1240a-e according to some embodiments are shown. The data storage devices 1240a-e may, for example, be utilized to store instructions and/or data such as the reclassification tiebreaking instructions 1142-1, risk assessment instructions 1142-2, underwriting instructions 1142-3, premium determination instructions 1142-4, client data 1144-1, business reclassification data 1144-2, underwriting data 1144-3, and/or claim/loss data 1144-4, each of which is presented in reference to FIG. 11 herein. In some embodiments, instructions stored on the data storage devices 1240a-e may, when executed by a processor, cause the implementation of and/or facilitate the methods 200, 300, 400, 1000 of FIG. 2, FIG. 3, FIG. 4, and/or FIG. 10 herein, and/or portions or combinations thereof.

According to some embodiments, the first data storage device 1240a may comprise one or more various types of internal and/or external hard drives. The first data storage device 1240a may, for example, comprise a data storage medium 1246 that is read, interrogated, and/or otherwise communicatively coupled to and/or via a disk reading device 1248. In some embodiments, the first data storage device 1240a and/or the data storage medium 1246 may be configured to store information utilizing one or more magnetic, inductive, and/or optical means (e.g., magnetic, inductive, and/or optical-encoding). The data storage medium 1246, depicted as a first data storage medium 1246a for example (e.g., breakout cross-section “A”), may comprise one or more of a polymer layer 1246a-1, a magnetic data storage layer 1246a-2, a non-magnetic layer 1246a-3, a magnetic base layer 1246a-4, a contact layer 1246a-5, and/or a substrate layer 1246a-6. According to some embodiments, a magnetic read head 1248a may be coupled and/or disposed to read data from the magnetic data storage layer 1246a-2.

In some embodiments, the data storage medium 1246, depicted as a second data storage medium 1246b for example (e.g., breakout cross-section “B”), may comprise a plurality of data points 1246b-2 disposed with the second data storage medium 1246b. The data points 1246b-2 may, in some embodiments, be read and/or otherwise interfaced with via a laser-enabled read head 1248b disposed and/or coupled to direct a laser beam through the second data storage medium 1246b.

In some embodiments, the second data storage device 1240b may comprise a CD, CD-ROM, DVD, Blu-Ray™ Disc, and/or other type of optically-encoded disk and/or other storage medium that is or becomes know or practicable. In some embodiments, the third data storage device 1240c may comprise a USB keyfob, dongle, and/or other type of flash memory data storage device that is or becomes know or practicable. In some embodiments, the fourth data storage device 1240d may comprise RAM of any type, quantity, and/or configuration that is or becomes practicable and/or desirable. In some embodiments, the fourth data storage device 1240d may comprise an off-chip cache such as a Level 2 (L2) cache memory device. According to some embodiments, the fifth data storage device 1240e may comprise an on-chip memory device such as a Level 1 (L1) cache memory device.

The data storage devices 1240a-e may generally store program instructions, code, and/or modules that, when executed by a processing device cause a particular machine to function in accordance with one or more embodiments described herein. The data storage devices 1240a-e depicted in FIG. 12A, FIG. 12B, FIG. 12C, FIG. 12D, and FIG. 12E are representative of a class and/or subset of computer-readable media that are defined herein as “computer-readable memory” (e.g., non-transitory memory devices as opposed to transmission devices or media).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A specially-programmed computerized processing device, comprising:
a computerized processor; and
a memory in communication with the processor, the memory storing specially-programmed instructions that when executed by the computerized processor result in:
receiving, from a user device, an indication of identifying information of a business for which an underwriting product is sought;
determining an initial business classification of the business;
providing, to the user device, a plurality of business classification questions;
receiving, in response to the providing of the plurality of business classification questions, at least one answer to the plurality of business classification questions;
determining, based on the at least one answer to the plurality of business classification questions, a business classification tie between at least two business classifications;
conducting a business classification tiebreaking that results in a selecting of one of the at least two business classifications as a final business classification for the business; and
determining at least one available insurance policy type based on the final business classification for the business.

2. The specially-programmed computerized processing device of claim 1, wherein the specially-programmed instructions, when executed by the computerized processor, further result in:
selling, to a customer, the at least insurance product of the at least one available insurance policy type.

3. The specially-programmed computerized processing device of claim 1, wherein the identifying information of the business comprises at least one of a business name, annual sales data for the business, annual payroll data for the business, and a business location.

4. The specially-programmed computerized processing device of claim 1, wherein the determining of the initial business classification is based on third-party data and the identifying information of the business.

5. The specially-programmed computerized processing device of claim 4, wherein the determining of the initial business classification based on the third-party data comprises querying, utilizing the identifying information of the business, a third-party database.

6. The specially-programmed computerized processing device of claim 4, wherein the third-party data comprises standardized business classification codes stored in association with geospatial location data.

7. The specially-programmed computerized processing device of claim 1, wherein the providing of the plurality of business classification questions occurs after the determining of the initial business classification.

8. The specially-programmed computerized processing device of claim 1, wherein the providing of the plurality of business classification questions occurs in response to the determining of the initial business classification.

9. The specially-programmed computerized processing device of claim 1, wherein the receiving of the at least one answer to the plurality of business classification questions comprises receiving a plurality of answers to the plurality of business classification questions.

10. The specially-programmed computerized processing device of claim 9, wherein each of the plurality of answers to the plurality of business classification questions indicates a different possible business classification of the business.

11. The specially-programmed computerized processing device of claim 10, wherein the conducting of the business classification tiebreaking that results in the selecting of the final business classification for the business comprises:
initiating a business classification tiebreaking algorithm; and
selecting, based on a result of the business classification tiebreaking algorithm, one of the different possible business classifications of the business as the final business classification of the business.

12. The specially-programmed computerized processing device of claim 1, wherein the receiving of the at least one answer to the plurality of business classification questions, comprises receiving, in response to each of the plurality of business classification questions, an indication of a value, each value being associated with one of the at least two business classifications.

13. The specially-programmed computerized processing device of claim 12, wherein the conducting of the business classification tiebreaking that results in the selecting of the one of the at least two business classifications as the final business classification for the business, comprises:
determining, for each of the at least two business classifications, a score;
multiplying, for each of the at least two business classifications, the score and the respective value, thereby defining a weighted score; and
selecting the final business classification as the one of the at least two business classifications that has the highest weighted score.

14. The specially-programmed computerized processing device of claim 12, wherein the conducting of the business classification tiebreaking that results in the selecting of the one of the at least two business classifications as the final business classification for the business, comprises:
determining that the values of the answers associated with the at least two business classifications are equal;
determining, for each of the at least two business classifications a risk ranking; and
selecting the final business classification as the one of the at least two business classifications that has the highest risk ranking.

15. The specially-programmed computerized processing device of claim 1, wherein the determining of the business classification tie based on the at least one answer to the plurality of business classification questions, comprises:
querying, utilizing the at least one answer, a database that correlates business classification question answers to possible business classifications.

16. The specially-programmed computerized processing device of claim 1, wherein the selecting of the one of the at least two business classifications as the final business classification for the business, comprises:
determining, for each of the at least two business classifications, a score; and
selecting the final business classification as the one of the at least two business classifications that has the highest score.

17. The specially-programmed computerized processing device of claim 16, wherein the score comprises a ranking indicative of a level of risk.

18. The specially-programmed computerized processing device of claim 1, wherein the specially-programmed instructions, when executed by the computerized processor, further result in:
receiving, from the user device, an indication of a selection of at least one selected insurance policy type, wherein each selected insurance policy type comprises an available insurance policy type;
receiving, from the user device, an indication of a desired coverage for each selected insurance policy type; and
providing, to the user device, a rate quote for each selected insurance policy type.

19. The specially-programmed computerized processing device of claim 18, wherein the specially-programmed instructions, when executed by the computerized processor, further result in:
creating a policy for each selected insurance policy type; and
receiving, from the user device, an indication that a customer desires to purchase the policy in response to the rate quote.
